(19) United States
(12) Patent Application Publication
(10) Pub. No.: US 2024/0345376 A1
(43) Pub. Date: Oct. 17, 2024

(54) SYSTEM AND METHOD FOR NANOSCALE AXIAL LOCALIZATION AND SUPER RESOLUTION AXIAL IMAGING WITH HEIGHT-CONTROLLED MIRROR

(71) Applicant: The George Washington University, Washington, DC (US)

(72) Inventor: Inhee Chung, Washington, DC (US)

(73) Assignee: The George Washington University, Washington, DC (US)

(21) Appl. No.: 18/642,730

(22) Filed: Apr. 22, 2024

Related U.S. Application Data
(63) Continuation-in-part of application No. PCT/US2022/047303, filed on Oct. 20, 2022.
(60) Provisional application No. 63/257,849, filed on Oct. 20, 2021.

(51) Int. Cl. G02B 21/00

(52) U.S. Cl. CPC G02B 21/0088; G02B 21/0064; G02B 21/0068; G02B 21/0072

(57) ABSTRACT

Systems and methods for microscopic imaging include an inverted microscope directed at a sample on a coverglass, where the sample is comprised of one or more cells and one or more chromophores. A ridge separates the coverglass from a silicon dioxide layer, and a silicon mirror is situated on the silicon dioxide layer, opposite the ridge and coverglass, while a weight is situated against the silicon mirror, opposite the silicon dioxide layer. The inverted microscope uses a spatial light modulator to diffract light through a linear polarizer and a filter wheel comprised of one or more Fourier filters. A beam or beams of s-polarized light is directed to the silicon mirror to create axial light modulation with its reflection on the silicon mirror, producing image data that is captured at a light detector.

### CROSS-REFERENCE TO RELATED APPLICATIONS

This application is a continuation-in-part of PCT/US2022/047303, filed Oct. 20, 2022, which claims the benefit of U.S. Provisional App. No. 63/257,849, filed Oct. 20, 2021, the entire contents of which are incorporated herein by reference.

### STATEMENT REGARDING FEDERALLY FUNDED RESEARCH

This invention was made with government support under Award No. 1945373 awarded by the National Science Foundation. The government has certain rights in the invention.

### FIELD OF THE INVENTION

The present invention is directed to devices and methods for microscopy.

### BACKGROUND OF THE INVENTION

Biochemical and cell biological readouts such as signaling and cell adhesion result from tightly orchestrated interactions of cell-surface proteins with the complex plasma membrane environment. Plasma membranes (PM) constantly reshape themselves into dynamic 3D structures with nanoscale topology. These topological changes can alter the distribution of cell-surface proteins, significantly affecting interactions between proteins and lipids on and near the PM thus changing the biological outcome. Thus, a truly mechanistic understanding of biological readouts at the PM requires imaging techniques that can visualize 3D nanoscale interactions. Moreover, real-time visualization of PM topological changes in live cells will inform the dynamic nature of nanoscale interactions.

Super-resolution microscopy is a form of light microscopy that breaks the diffraction limit of light, providing a higher resolution than conventional optical microscopes. The diffraction limit refers to the fundamental limit to the resolution that can be achieved with any optical imaging system. It is defined by the formula: Resolution=λ/(2NA), where λ represents the wavelength of light and NA represents the numerical aperture of the objective lens. The numerical aperture (NA) of a microscope objective is a measure of its ability to gather light and resolve fine specimen detail at a fixed object distance. For example, Structured Illumination Microscopy (SIM), a form of super-resolution microscopy, can enhance optical resolution by two-fold in comparison to conventional microscopy.

Widefield-based super-resolution methods such as 3D structured illumination microscopy (3D-SIM) can achieve twice the axial (˜300 nm) and lateral (˜100 nm) resolution of widefield microscopy in real time in live cells 13. This resolution improvement has enabled monitoring of various plasma membrane events and sub-cellular organelles in real time. However, twice-resolution enhancement cannot sufficiently visualize nanoscale fine structures of the plasma membrane. Fluorescence interference contrast microscopy (FLIC) is a widefield microscopy technique that incorporates optical interferometry to perform nanometer-scale axial localization. FLIC creates an axial interference pattern along the excitation beam path due to self-interference of an incident beam with its reflection off a silicon (Si) mirror covered with a step-wise patterned silica (SiO₂) layer. Theoretically, FLIC can offer axial localization information of a thin object such as the PM, but it cannot localize thicker objects with extensive placement of chromophores in the axial direction. While FLIC has some limited applications for axial localization of the PM, it requires uniform chromophore labeling of the sample surface and a sample size that spans multiple micron-sized SiO₂ oxide steps.

Subsequent FLIC derivative methods with varying incidence angles, such as scanning angle interference microscopy (SAIM), do not have such constraints and do not require SiO₂ patterning to achieve nanoscale topological mapping. SAIM can be used for axial localization in live cells at ˜0.3 Hz19. Lateral imaging is diffraction-limited and most SAIM applications have been primarily used to map the topology of the basal cell surface, focal adhesion sites, and cytoskeletons underneath the basal cell surface that was adhered to the SiO₂/Si mirror. There have been fewer attempts to map the apical cell surface on the SiO₂/Si mirror, probably due to the high background incorporated into the signal and increased fitting uncertainty. https://doi.org/10.1038/nmeth.2077; Carbone, C., Vale, R. & Stuurman, N. An acquisition and analysis pipeline for scanning angle interference microscopy. Nat Methods 13, 897-898 (2016). https://doi.org/10.1038/nmeth.4030) or model membranes (Carbone, C., Kern, N., Fernandes, R., et al. In vitro reconstitution of T cell receptor-mediated segregation of the CD45 phosphatase. PNAS 114 (44) E9338-E9345 (2017). https://doi.org/10.1073/pnas. 1710358114; Carbone, C., Vale, R. & Stuurman, N. An acquisition and analysis pipeline for scanning angle interference microscopy. Nat Methods 13, 897-898 (2016). https://doi.org/10.1038/nmeth.4030) or osmotically ruptured cells in which the top plasma membrane lipid bilayer as well as nuclei were removed to reduce noise in the raw data (Paszek, M., DuFort, C., Rubashkin, M. et al. Scanning angle interference microscopy reveals cell dynamics at the nanoscale. Nat Methods 9, 825-827 (2012). https://doi.org/10.1038/nmeth.2077; Christopher DuFort & Matthew Paszek, Chapter 13-Nanoscale cellular imaging with scanning angle interference microscopy, Jennifer C. Waters & Torsten Wittman (Eds.), Methods in Cell Biology, Academic Press, Vol. 123, 2014, pgs. 235-252.)

To enable robust topological mapping of both basal and apical cell surfaces, while achieving excellent height reconstruction fidelity and time resolution, as well as super-resolution lateral imaging, we developed multi-angle-crossing structured illumination microscopy (MAxSIM) with a height-controlled mirror (HCM) and a substantially improved nonlinear-least-square based fitting algorithm. Instead of placing cells only on the SiO₂/Si mirror, cells can also be located on the bottom of the glass substrate with a custom-fabricated HCM (a standard 1-μm-thick SiO₂-covered Si mirror with a ridge structure) that is located at a specific distance above the cells (FIG. 1A, B). The ridge height of the HCM enables a preliminary estimation of the initial height parameter, which is the most crucial factor for fitting fidelity. The HCM also allows users to select an optimal ridge height for a given cell type to further improve height reconstruction fidelity. The HCM is reusable, thus saving the time and costs required for fabrication. Our vastly optimized fitting algorithm overcomes the challenges of fitting noisy raw data to the theoretical formula by determining the best initial height parameter and optimal subangle ranges for fitting. The optoelectronic control of varying incidence angles is used both for axial interferometry and 2D-SIM, thus the super-resolution lateral imaging is enabled. All of these improvements offered by our MAxSIM platform enable 3D topology mapping of live cells in near-real-time (˜0.5 Hz), combined with 3D single-molecule tracking, which we showcase by imaging the apical and basal surfaces of fixed and live cells of diverse types.

Widefield-based super-resolution methods such as 3D-structured illumination microscopy (3D-SIM) can achieve twice the axial (˜300 nm) and lateral (˜100 nm) resolution of widefield microscopy in real time in live cells. This resolution improvement has enabled monitoring of various plasma membrane events and sub-cellular organelles in real time. However, twice-resolution enhancement cannot sufficiently visualize nanoscale fine structures of the plasma membrane. Fluorescence interference contrast microscopy (FLIC) is a widefield microscopy technique that incorporates optical interferometry to perform nanometer-scale axial localization 14. FLIC creates an axial interference pattern along the excitation beam path due to self-interference of an incident beam with its reflection off a silicon (Si) mirror covered with a step-wise patterned silica (SiO₂) layer. Theoretically, FLIC can offer axial localization information of a thin object such as the PM, but it cannot localize thicker objects with extensive placement of chromophores in the axial direction. While FLIC has some limited applications for axial localization of the PM, it requires uniform chromophore labeling of the sample surface and a sample size that spans multiple micron-sized SiO₂ oxide steps.

Real-time nanoscale cell-surface 3D topology mapping remains challenging despite development of various super-resolution optical techniques. For instance, widefield-based super-resolution methods such as 3D-structured illumination microscopy (3D-SIM) can achieve twice the axial resolution (˜400 nm) of widefield microscopy by creating 3D interference patterns for sample excitation. Further, 4Pi and I⁵M microscopy attain seven-times the axial resolution (˜100 nm) of widefield microscopy by generating axial interference patterns using two opposing objectives. 3D localization-based microscopy, such as interferometric PALM (iPALM) (localization precision <20 nm), 3D-STORM (20-30 nm), and point spread function engineering methods (10-20 nm), also perform axial localization with high precision. However, most of these approaches can be experimentally challenging due to cumbersome sample placement geometry and long data collection times.

Nevertheless, FLIC has some limited applicability for axial localization of the PM. It requires an assumption that the microscale region of the sample placed on each SiO₂ step of the substrate is homogenous and flat, which does not apply to PMs with dynamic topological features. Moreover, the height retrieval in FLIC requires an additional reference intensity measurements on a different oxide step with the known height difference from the one where the actual measurement is made.

However for the PM, such reference measurement is not amenable due to the unflatness of the PM. Additionally for FLIC, oxide thickness needs to be carefully chosen for the specific height of an object to obtain highly contrasting axial interference patterns of the objects, which is not amenable for detecting cell topology with unknown and not uniform height information. Subsequent FLIC derivative methods with varying incidence angles, such as scanning angle interference microscopy (SAIM), do not require the above-mentioned constraints and successfully remove the need for SiO₂ patterning to achieve nanoscale topological mapping. SAIM can be used for axial localization in live cells but at a slow acquisition rate (at 10-1˜10-2 per second). The low time resolution of SAIM may be caused by low fidelity and poor height reconstruction due to the close and unknown axial location of the mirror relative to a chromophore and unoptimized fitting algorithms for noisy raw data, along with mechanical control of the incidence angle scan. Furthermore, the lateral imaging is diffraction limited and imaging the top part of cells is precluded due to restricted cell placement on the SiO₂/Si mirror. Such imaging has mostly mapped the topology of fixed cells the present technology seeks to remedy those and other deficiencies in the art.

### SUMMARY OF THE INVENTION

The above methodological limitations can be improved by one or more of the following: 1) enabling to locate cells in bottom glass substrate at an optimal and known axial location from a mirror, which enables the assignment of an optimal and accurate initial fitting parameter of the height for high-fidelity height reconstruction for a given cell-type and also retrieves height information from both the top and bottom of cells, 2) optimizing the height reconstruction algorithm to fit the noisy raw data, 3) using optoelectric control of varying incidence angles, and 4) incorporating the super-resolution 2D-SIM for lateral imaging.

In one embodiment, a multi-angle-crossing structured illumination microscopy (MAxSIM) with a height-controlled mirror (HCM) addresses these limitations. Instead of placing cells on the mirror, cells are located on the bottom of the glass substrate, with a custom fabricated HCM with ridge structure located at a specific and optimal distance above the cells (FIGS. 1A, B).

The number of interference fringes depends on the SiO₂ thickness as well as the height of a chromophore, as demonstrated by our simulated data (FIGS. 6E, 6F). Different SiO₂ thicknesses such as 500 nm or 10 μm (both are commercially available) yield similar (in the 500 nm case) or more excitation interference fringes (in the 10 μm case) than for the 1 μm thick SiO₂ case³⁴. An adequate number of modulation fringes within an incident angle range is crucial to yield high-fidelity height reconstruction. For instance, h<1,000 nm empirically leads to poor reconstruction when using a Si mirror covered with a 1-μm-thick SiO₂ layer, as demonstrated by the example raw data and fitted curves for 100 nm microspheres placed on a SiO₂/Si mirror. A chromophore distance >5 μm away from the 1-μm-thick SiO₂-covered Si mirror creates many fluorescence interference fringes and enables higher-fidelity height reconstruction using our algorithm, compared to shorter distances (<1 μm). This reinforces the advantage of using an HCM with an optimal ridge height positioned above cells located on a bottom glass substrate, instead of placing cells directly on the SiO₂/Si mirror as used in SAIM. Additionally, the HCM ridge enables precise vertical placement of the mirror on the optical axis, which cannot be achieved by the previous scheme ((see Paszek, M., DuFort, C., Rubashkin, M. et al. Scanning angle interference microscopy reveals cell dynamics at the nanoscale. Nat Methods 9, 825-827 (2012)) in which a weight is placed on the cell-plated SiO₂/Si mirror to prevent floating. Our method also allows custom selection of the ridge height that leads to high-fidelity height reconstruction of a specific cell.

A chromophore location >5 μm away from a mirror that gives rise to more fluorescence interference fringes enables higher fidelity height reconstruction than in the case of closer locations (<1 μm) of chromophores to the 1 μm SiO₂ coated Si mirror, due to the high uncertainty in fitting one or two fringes incorporated with experimental noise. The latter condition can occur when imaging the cell bottom placed on a mirror as done for SAIM instead of a glass substrate. The ridge height of the HCM enables determining the initial height parameter, the most critical fitting parameter for fitting fidelity. By placing cells on the bottom glass substrate distanced by a ridge height from the HCM, rather than on the mirror, MAxSIM can determine the height information of the chromophores on both the top and bottom of a cell and allows users to select an optimal ridge height for a given cell type to improve height reconstruction fidelity further. MAxSIM enables 2D-SIM that can improve lateral imaging resolution. Moreover, cell placement on the glass side enhances 2D-SIM imaging compared to cells farther from an objective. Lastly, the HCM is reusable, saving time and money because fabrication is time-consuming and costly.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a diagram of an exemplary optical layout of an exemplary embodiment of the present system;

FIG. 1B is a diagram of the fabrication process used to build an exemplary embodiment of the height-controlled mirror (HCM) of the present system;

FIG. 1C is a diagram of exemplary diffraction patterns uploaded on the spatial light modulator (SLM) to achieve an incident angle;

FIG. 1D is a diagram of simulated excitation light intensity patterns (2=488 nm) in x-z dimensions with the presence of a mirror using one beam excitation with incident angle θ_{w}=19° (top, MAxSIM) and two symmetric beams with incident angle θ_{w}=60° (bottom, 2D-SIM);

FIG. 1E is a graph showing simulated light intensity modulations, I(θ,h), using one beam excitation as a function of the incident angle in air (θ_{w}, top x-axis) and in water immersion medium (θ_{w}, bottom x-axis) at axial locations at the tip of ridges, h°=10, 100, 1,000, and 10,000 nm away from the HCM. The number of intensity modulations increases at a higher position from the mirror;

FIG. 1F is a graph showing measured incident-angle-dependent fluorescence light intensity modulation of Alexa 488 dye on the bottom glass substrate with the presence of ˜10.7-μm-high HCM with excitation λ=488 nm, normalized between (0, 1) (gray dashed line). Fitting range (between purple vertical bars) of the best performance was selected by our algorithm, and height (h⁰) was retrieved at 8,255 nm with ˜0.7% fitting uncertainty (NELD=0.007) from the fitted solid line (orange) using custom reconstruction software;

FIG. 1G shows 2D-SIM imaging of live SKBR3 cells, which is enabled by the same MAxSIM hardware. Scale bar=5 μm;

FIG. 2A shows reconstructed MAxSIM images (2D height map and 3D topology image) and 2D NELD map of fixed cell samples, visualizing MCF7 with low HER2 expression. Scale bars=10 μm;

FIG. 2B shows reconstructed MAxSIM images (2D height map and 3D topology image) and 2D NELD map of fixed cell samples, where HER2 overexpresser SKBR3 with deformed membranes are stained with wheat germ agglutinin-conjugated Alexa 555 (WGA-555). Scale bars=10 μm;

FIG. 2C shows reconstructed MAxSIM images (2D height map and 3D topology image) and 2D NELD map of fixed cell samples, visualizing naïve B cells. Scale bars=2 μm;

FIG. 2D shows reconstructed MAxSIM images (2D height map and 3D topology image) and 2D NELD map of fixed cell samples, visualizing germinal center B cell with previously observed pod-like structures are labeled for B cell receptor with Dylight 550-conjugated Fab fragments of antibodies against IgG or IgM heavy chain. Scale bars=2 μm;

FIG. 2E shows reconstructed MAxSIM images (2D height map and 3D topology image) and 2D NELD map of fixed cell samples for primary cortical cultures from Long Evans rat embryos stained with WGA-555. Scale bars=2 μm;

FIG. 2F shows reconstructed MAxSIM images (2D height map and 3D topology image) and 2D NELD map of fixed cell samples for primary cortical cultures from Long Evans rat embryos stained with anti-GluA2-Atto647N antibody. Scale bars=2 μm;

FIG. 2G shows a merged 3D topology image of WGA (gray) and GluA2 (red) masked by the intensity-thresholded 2D-SIM image (excitation numerical aperture=1.15) of GluA2. Scale bars=2 μm;

FIG. 2H shows 3D cell surface morphology mapping using MAxSIM with HCM. It is a 3D topology image and zoomed-in image of specific areas (indicated by white boxes) of fixed cell samples are reconstructed from the raw MAxSIM images obtained by scanning the incidence angle (19°, 53°) with a 0.5° step size. 2D NELD maps demonstrate overall high fitting fidelity, with most values smaller than 0.1. MCF7 cells with low HER2 expression (basal);

FIG. 2I shows 3D cell surface morphology mapping using MAxSIM with HCM. It is a 3D topology image and zoomed-in image of specific areas (indicated by white boxes) of fixed cell samples are reconstructed from the raw MAxSIM images obtained by scanning the incidence angle (19°, 53°) with a 0.5° step size. 2D NELD maps demonstrate overall high fitting fidelity, with most values smaller than 0.1. MCF7 cells with SKBR3 cells overexpressing HER2 with deformed membranes (basal) were stained with wheat germ agglutinin-Alexa 555 conjugates (WGA-555).

FIG. 2J shows the basal cell surfaces of a naive B cell and FIG. 2K shows a germinal center (GC) B cell with pod-like structures labeled for B cell receptor with Dylight 550-conjugated Fab fragments of antibodies against IgG or IgM heavy chain. Height scales were determined to include fitted heights with NELD<0.1. A median filter with a kernel size=2 was applied to reduce noise in FIGS. 2H-2K. Exposure time=200 ms FIGS. 2H-2K. Scale bars=5 μm FIGS. 2H-2I and 2 μm FIG. 2K.

FIG. 2L shows 3D cell surface protein localization by MAxSIM combined with 2D-SIM imaging-based spatial mask. FIGS. 2L, 2M, 2N, 2O. Diffraction-limited lateral image d and super-resolution 2D-SIM image with excitation numerical aperture=1.15 e of GluA2 on the dendrite. A fast Fourier transform image was generated (FIG. 2N), and intensity thresholding was applied to create a mask FIG. 2O from the 2D-SIM image FIGS. 2M, 2P Merged 3D topology image of WGA (gray) and GluA2 (red) incorporating the mask FIG. 2O. A median filter with kernel size=3 was applied to reduce noise a-c, h. Scale bars=2 μm FIGS. 2L, 2M, 2O, 2P.

FIG. 3A shows a live-cell 3D cell-surface morphology mapping at 1.9 s per topology map (0.52 Hz) (incident angle range (19°, 33°) with 0.5° step and 50 ms exposure time). 2D height, 3D topology, and NELD images are shown at time 0;

FIG. 3B shows a live-cell 3D cell-surface morphology mapping at 1.9 s per topology map (0.52 Hz) (incident angle range (19°, 33°) with 0.5° step and 50 ms exposure time). 2D height, 3D topology, and NELD images are shown at time 20.9 s;

FIG. 3C shows live-cell topological mapping and 3D single-molecule tracking by MAXSIM. FIGS. 3C, 3D show live-cell 3D basal surface morphology mapping of SKBR3 cells at 1.9 s per topology map, equivalent to 0.52 Hz. The incident angle range was (19°, 35°) with 0.5° step size, and a 50-ms exposure time was used. The images show 3D topology, zoomed-in views of specific regions marked by white boxes, and 2D NELD images at time 0 (FIG. 3C) and 20.9 s (FIG. 3D). A median filter with kernel size of 2 was applied to reduce noise a-d. Scale bars=10 μm (FIGS. 3C, 3D).

FIG. 4 is a diagram showing one-beam MAxSIM geometry for cells on the glass substrate;

FIG. 5A is a diagram showing simulated results of the two beam (+1 order beams) interference pattern in x-z without the presence of a mirror located perpendicular to the optical axis, as well as the lateral interference profile at the z position of 300 nm;

FIG. 5B is a diagram showing simulated results of the two beam (+1 order beams) interference pattern in x-z with the presence of a mirror located perpendicular to the optical axis, as well as the lateral interference profile at the z position of 500 nm;

FIG. 6A is a graph a showing simulated incident-angle-dependent excitation intensity modulation pattern with a silicon dioxide (SiO₂) layer thickness of 1 μm in the HCM at h=10 μm;

FIG. 6B is a graph a showing simulated incident-angle-dependent excitation intensity modulation pattern with a silicon dioxide (SiO₂) layer thickness of 5 μm in the HCM at h=10 μm;

FIG. 6C is a graph a showing simulated incident-angle-dependent excitation intensity modulation pattern with a silicon dioxide (SiO₂) layer thickness of 10 μm in the HCM at h=10 μm;

FIG. 6D is a calibration curve that compares the measured incidence angles (two independently measured angles; circles; mean values; triangles) produced by the SLM (Theoretical angle; X-axis); two independent measurements (n=2) taken to provide mean and standard deviation values; the plotted values indicate that the measured incidence angles are <2% of the theoretical angles;

FIG. 6E shows the excitation intensity interference pattern at 2=488 nm simulated for three different SiO₂ thickness cases: D_{OX}=0.5, 1, and 10 μm, along with three different chromophore heights: h=1, 10, and 20 μm from the SiO₂ layer. The results indicate that the number of interference fringes increases with larger values of D_{OX} and higher chromophore locations (h). The figure shows the fringes plotted, revealing that the cases with D_{OX}=0.5 μm and 1 μm produce a similar number of interference fringes, while the case with D_{OX}=10 μm produces significantly more fringes;

FIG. 6F shows the number of fringes counted from the simulated curves;

FIG. 7 is a graph where theoretical height (h) localization precision is calculated and plotted for the h from 5 to 25 μm every 1 nm. The h localization precision is calculated from the normalized difference of the observed (hₒ) and theoretical (hₑ) heights. Y axis: | (hₒ−hₑ)|/hₑ; X axis: hₑ=5 to 25 μm at every 1 nm;

FIG. 8A shows simulated results of the one and two beam (±1 order beams) interference patterns in x-z at an incidence angle θ=19° with the presence of a mirror located perpendicular to the optical axis. The two vertical lines (left; solid and right; dashed) are located at the minimum (x=375) and the maximum (x=749) intensity locations shown in the two-beam case. The following constant values were used for the simulation curves: λ=488 nm, nₛᵢ=4.37, n_{oxide}=1.46, n_{media}=1.33, and the oxide layer thickness=1,000 nm;

FIG. 8B shows simulated results of the one and two beam (+1 order beams) interference patterns in x-z at an incidence angle θ=19° with the presence of a mirror located perpendicular to the optical axis. The two vertical lines (left; solid and right; dashed) are located at the minimum (x=375) and the maximum (x=749) intensity locations shown in the two-beam case. The following constant values were used for the simulation curves: λ=488 nm, nₛᵢ=4.37, n_{oxide}=1.46, n_{media}=1.33, and the oxide layer thickness=1,000 nm. Intensity profiles in θ-z dimensions at the two x positions defined in a, as θ° vary from 19° to 53° with a stepsize of 0.5° for the one and two beam cases. Orange (left; solid) and green (right; dashed) lines indicate z=500 nm;

FIG. 8C shows simulated results of the one and two beam (+1 order beams) interference patterns in x-z at an incidence angle θ=19° with the presence of a mirror located perpendicular to the optical axis. The two vertical lines (left; solid and right; dashed) are located at the minimum (x=375) and the maximum (x=749) intensity locations shown in the two-beam case. The following constant values were used for the simulation curves: λ=488 nm, nₛᵢ=4.37, n_{oxide}=1.46, n_{media}=1.33, and the oxide layer thickness=1,000 nm. Intensity profiles in-z dimensions at the two x positions defined in a, as θ° vary from 19° to 53° with a stepsize of 0.5° for the one and two beam cases. Orange (left; solid) and green (right; dashed) lines indicate z=500 nm;

FIG. 8D shows graphs of the intensity modulation profiles along the lines shown in FIGS. 8B and 8C overlaid for one (left; solid) and two (right; dashed) beam cases that show the modulation patterns vary laterally for the two beam case, while in the one-beam condition, those patterns are laterally invariant;

FIG. 9A is a raw MAxSIM image of Alexa-488-IgG1 spin-coated on the glass substrate taken at the incident angle of the 488 nm laser light at using the 10.7 μm high HCM. Four pixel locations are indicated for demonstrating the high fitting fidelity show in FIG. 10D. The roughness in the ROI (yellow box) is ˜0.001. Different heights can be inferred from different color scale shown in the scale bars;

FIG. 9B is shows a representation of the reconstructed MAxSIM images in 3D. Different heights can be inferred from different color scale shown in the scale bars;

FIG. 9C is a 2D representation of NELD values, demonstrating the excellent fitting fidelity based on the <0.1 NELD values calculated for the selected angle ranges for fitting (purple vertical bars). The average NELD value was 0.035;

FIG. 9D shows four graphs where gray and orange dotted dashed lines are processed raw data and fitted plots from the four pixels in FIG. 9A. The h values were retrieved at 8,636 (pixel #1), 8,522 nm (#2), 8,561 nm (#3), and 8,340 nm (#4);

FIG. 10A is a graph of NELD value calculations using a random initial height value of approximately 15,000 nm;

FIG. 10B is a graph of NELD value calculations using a random initial height value of approximately 17,000 nm;

FIG. 10C is a graph of NELD value calculations using the fitting algorithm of the present technology;

FIG. 11 is a flow diagram of an exemplary fitting algorithm used by the present system for height reconstruction;

FIG. 12A shows for cells overexpressing HER2, the plasma membrane undergoes compartmentalization characterized by distinct mechanical properties in terms of membrane tension and bending modulus. Analysis of height fluctuation data obtained from MAxSIM reveals that both membrane tension and bending modulus exhibit compartmentalization on the basal plasma membrane of SKBR3 cells (3+);

FIG. 12B shows the compartmentalization of FIG. 12A is largely absent in MCF7 cells;

FIG. 12C shows treatment with 5 μM latrunculin A for 30 minutes results in significant reduction of the mechanical compartmentalization on the basal plasma membrane of SKBR3 cells due to actin depolymerization;

FIG. 13A shows an Azimuthal polarizer;

FIG. 13B shows fourier filter masks, including an Axial interferometry mask (left) and a 2D-SIM mask (right); and,

FIGS. 14A, 14B, 14C, 14D show simulations results of interference of 3D-SIM beams.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes, it being understood that the invention may be embodied in other forms not specifically shown in the drawings.

Fluorescence interference contrast microscopy (FLIC) is a widefield microscopy technique that incorporates optical interferometry to perform nanometer-scale axial localization. FLIC creates an axial interference pattern as a result of self-interference of an incident beam reflected off a silicon surface (coated with step-wise patterned silica (SiO₂) layer) along the excitation beam path. Theoretically, FLIC can offer the axial localization information of an axially “thin” object such as the PM or cytoskeletal elements including actin, while it is not amenable for localizing thicker objects with extensive placements of chromophores in the axial direction.

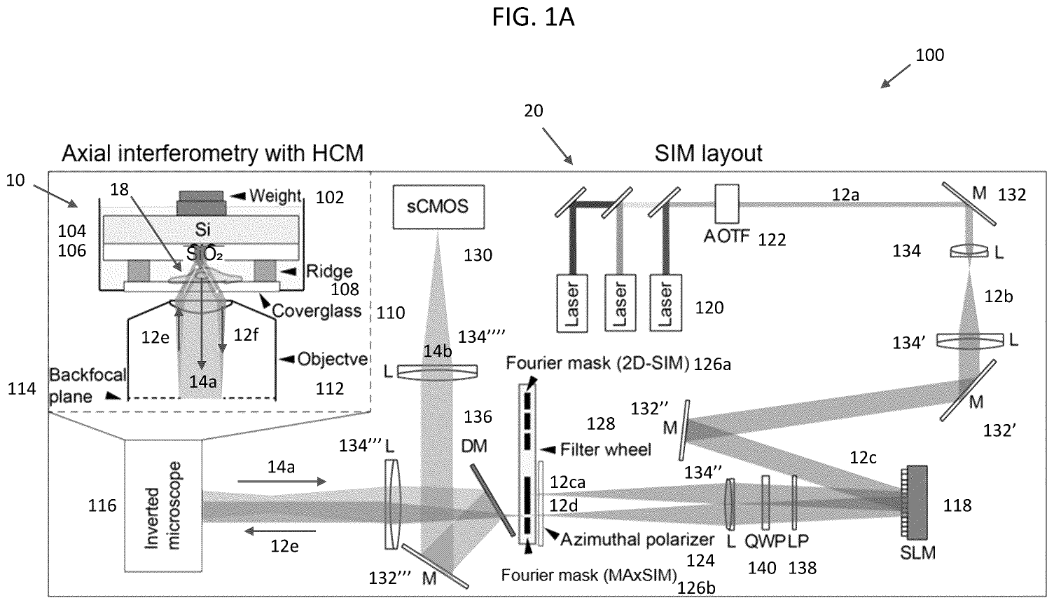

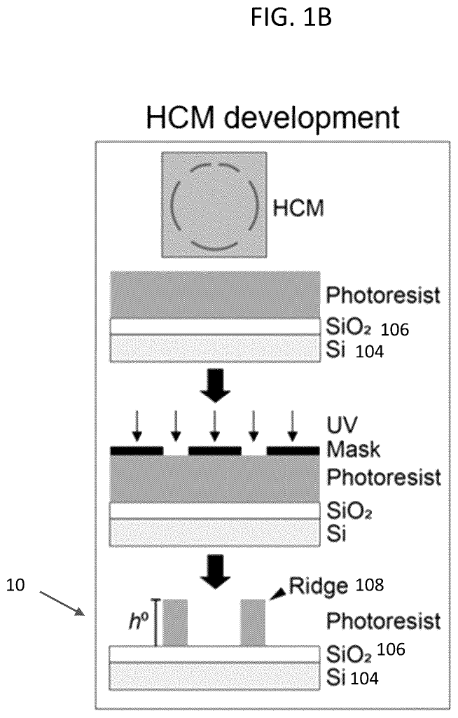

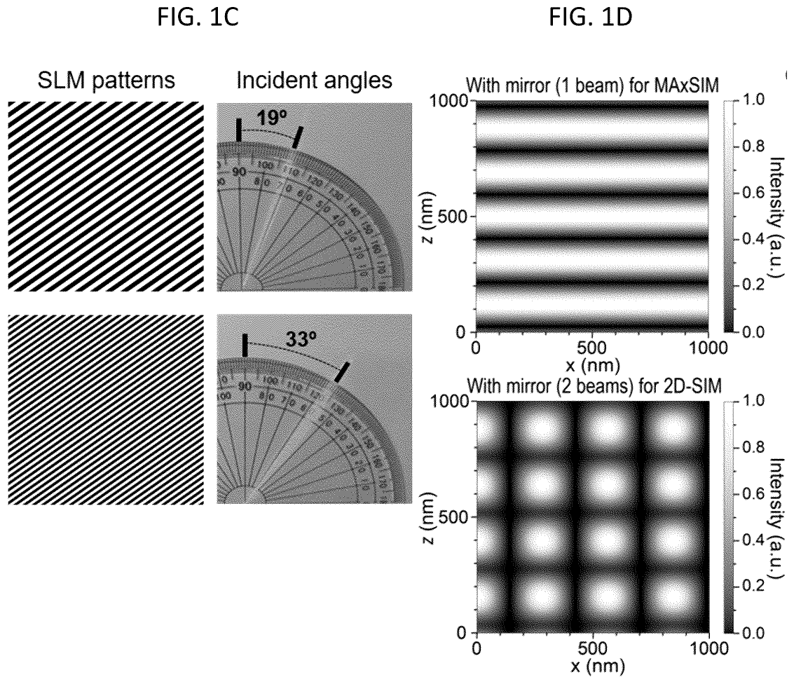

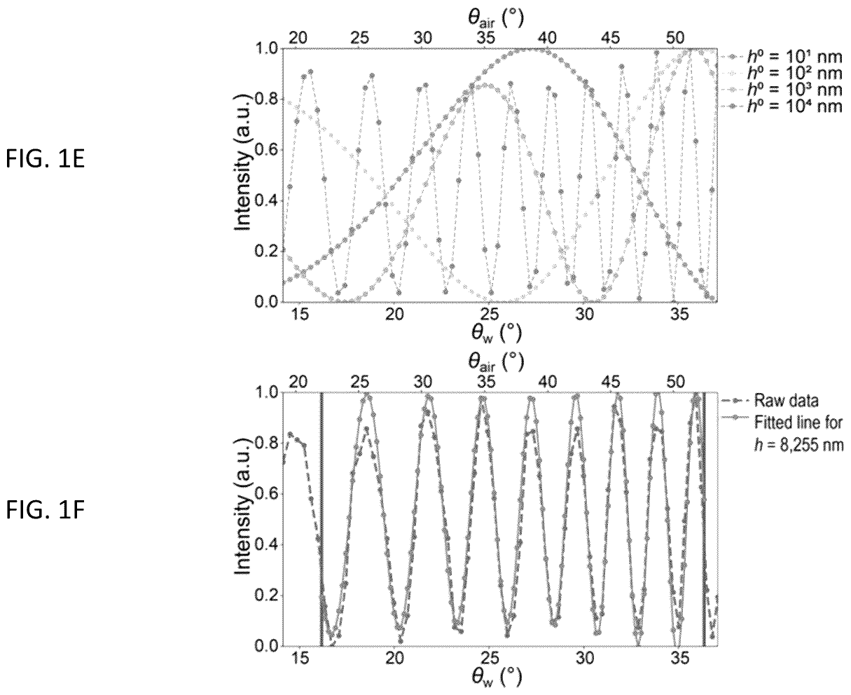

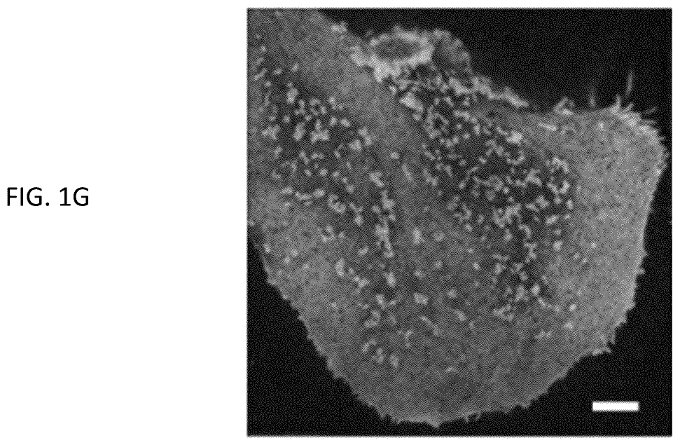

The basis of MAxSIM is a custom SIM system to generate excitation lights at multiple incident angles to create incident-angle-dependent axial interference patterns with the presence of HCM along the optical axis (FIG. 1A). SIM is a widefield microscopy technique that breaks the diffraction limit by patterning excitation light beams. As previously done by various groups, we used a spatial light modulator (SLM; 2048×1536 pixels) that creates a grid pattern in the light path for diffraction. Diffracted beams from the SLM become s-polarized by the azimuthal linear polarizer (FIG. 1A, FIG. 13A) as used in fastSIM. Subsequently, one or two beams are selected using Fourier filters (FIG. 13B) installed in a filter wheel located at the conjugate plane of the objective backfocal plane for MAxSIM (+1st-order beam). The high-speed filter wheel (filter switching time<30 ms) allows different imaging modes for the same cells. For instance, the selection of the ±1st-order diffraction beams enables 2D-SIM imaging of the same cells, even with the presence of an HCM, as lateral interference of the symmetric ±1st-order beams remains intact with the HCM. The selected s-polarized diffraction beams form a grating pattern through interference at the sample plane (FIG. 1D). Separation of the two beams for 2D-SIM was selected for optimal excitation numerical aperture.

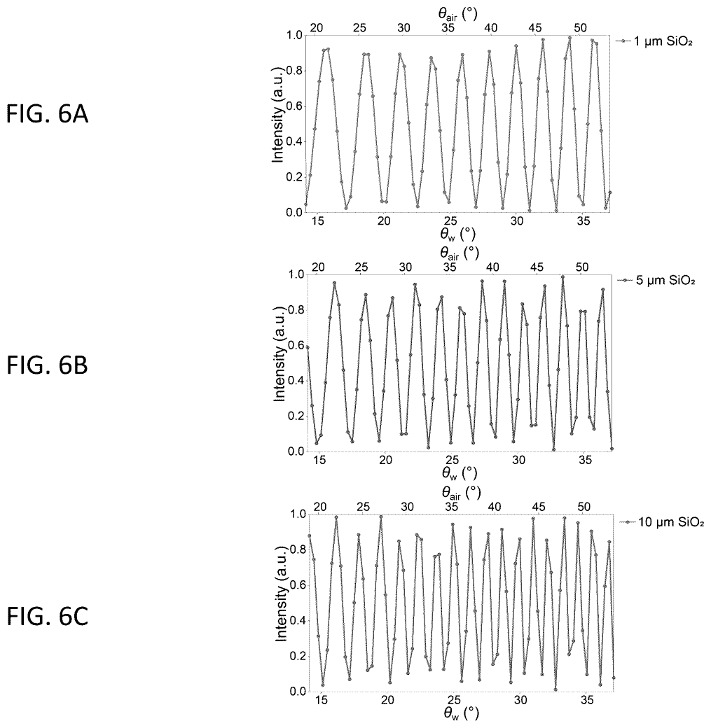

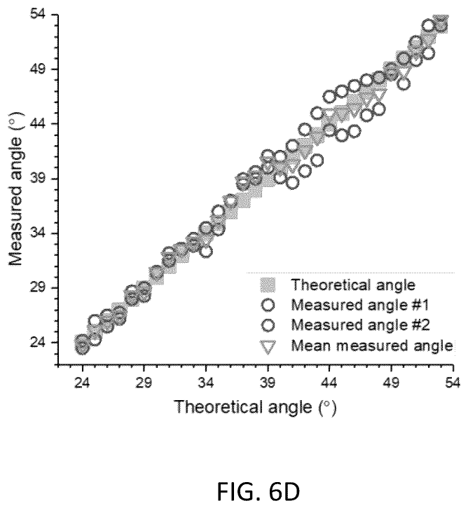

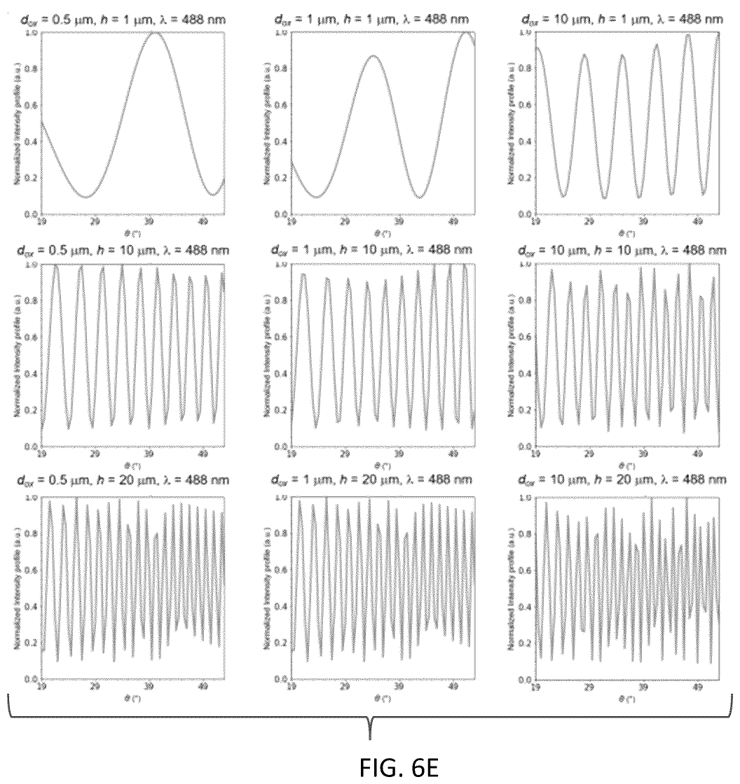

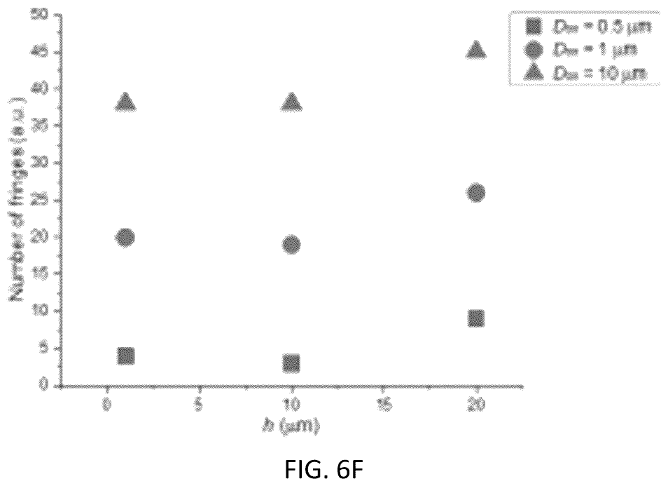

In axial interferometry with HCM, one s-polarized +1st-order beam was chosen to create axial light interference ridges with its reflection off the Si surface in the HCM (FIG. 1A). The HCM was fabricated by depositing a 1-μm-thick SiO₂ layer as used for SAIM36 on a high-quality Si mirror and then further processing via lithography to produce a ridge (preferably 5-30-μm heights) (FIG. 1B). Through simulation, we found greater SiO₂ thickness increases the number of excitation intensity modulation fringes (FIGS. 6A-6C). Since the number of fringes also increases with greater ridge height, 1 μm oxide thickness would offer more tunable ranges of the ridge height than the other commercially available SiO₂ thickness including 5 and 10 μm. Our calibration data demonstrates excellent accuracy, as the incident angles are within a remarkable 2% margin of error compared to the theoretical angles (FIG. 6D).

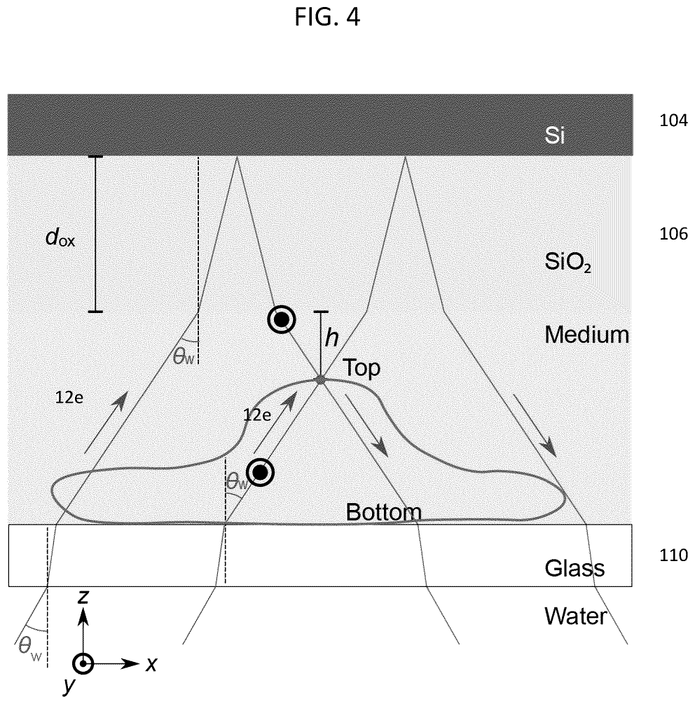

Turning to the drawings, FIG. 1A and FIG. 4 show a non-limiting example embodiment of a MAxSIM 100 having an HCM 10, inverted microscope 116, and SIM apparatus or layout 20. The HCM 10 has a mirror layer 104 and a support member, here shown as the ridges 108. The mirror layer 104 reflects light, and the light modulation layer 106, here shown as the SiO₂ layer 106, is located over the mirror layer 104 to modulate the light. As best shown in FIG. 4, incoming excitation light 12e passes through a sample or cell 18 (and any surrounding medium), then the light modulating SiO₂ layer 106, strikes the mirror 104, 106 and is reflected back out through the cell 18. In axial interferometry with HCM, one s-polarized +1^{st}-order beam 12e was chosen to create axial light modulation 14a with its own reflection off the Si surface in the HCM.

Referring momentarily to FIG. 1B, the HCM 10 can be fabricated by depositing a 1-μm-thick SiO₂ layer 106 on a high-quality Si mirror 104 and then further processing, for example, via lithography using a UV mask placed over a photoresist layer, to produce a ridge 108, preferably with a height of 5-25 μm. The thickness of the SiO₂ layer 106 and the Si mirror 104 can be modulated as necessary for different cell samples based on the theoretical simulations. In addition, the materials (SiO₂ and Si) used to form the SiO₂ layer 106 and the Si mirror 104 may be replaced with substitute materials, as known to those of ordinary skill in the art. The thickness of the light modulation layer 106 (SiO2) layer on the mirror controls height accuracy. The thickness of the light modulation layer 106 changes the light beam and the interference pattern as evidenced by the simulation results in FIG. 6E. Using an adequately thick SiO₂ layer can reduce the overall height, which in turn may decrease height accuracy, since accuracy is proportional to the object's height.

Returning to FIG. 1A, a weight 102 is situated on top of the Si mirror 104 to prevent the HCM from floating. A coverglass 110 is placed on the ridges 108, so that the ridges 108 are situated between the coverglass 110 and the SiO₂ layer 106. The ridges 108 separate the Si mirror 104 and the SiO₂ layer 106 from the coverglass 110, where sample 18 can be rested on. The ridge 108 height is predetermined and known, so can be readily accounted for in predicting the raw data from MAxSIM imaging. Thus, the Si layer 104 has an Si top surface on which a weight 102 is placed, and an Si bottom surface. The SiO₂ layer 106 has an SiO₂ top surface in contact with the Si bottom surface, and an SiO₂ bottom surface. The ridge 108 can be a continuous ring or one or more separate discrete structural members. The ridge(s) 108 have a ridge top surface that contacts the SiO₂ bottom surface, and a ridge bottom surface. The coverlgass 110 is flat and can have a circular, rectangular or square shape, and has a coverglass top surface that contacts the ridge bottom surface, and a coverglass bottom surface.

Referring to FIGS. 1A, 4, the sample 18 is placed on the coverglass top surface, between the ridges 108. Placing the sample 18 on the coverslip (glass) 110 enables adjusting the ridge height h (the distance between the chromore location on the sample 18 and the SiO₂ bottom layer) and allows for better axial localization. Thus, the height of the ridge 108 can be selected based on the application. The ridge 108 creates a known distance or gap between the SiO₂ layer 106 and the coverglass top surface. In certain embodiments, the ridge 108 may be fabricated on a silicon chip. Or, a structure different than a ridge 108 can be provided to form a gap between the SiO₂ layer 106 and the sample 18 on the coverglass 110. Or the sample 18 can be placed on the SiO₂ bottom surface.

Referring to FIG. 1A, the SIM layout 20 generally modulates the incident angle of excitation light 12e. The SIM 20 generally includes a light source, here lasers 120, an SLM 118, and a mask 126, as well as various optical components such as lenses 134, 134′, 134″, polarizer 138, Quarter Wave Plate (QWP) 140, and mirrors 132, 132′, 132″. A plurality of lasers 120, each at a different wavelength, send light to the acousto-optic tunable filter (AOTF) 122, which selects the light wavelength to use for the given application. The AOTF is an electro-optical device that functions as an electronically tunable excitation filter to simultaneously modulate the intensity and wavelength of the multiple laser lines.

Once filtered at the AOTF 122, that input light beam 12a is transmitted to the SLM 118 using one or more lenses 134, 134′ and one or more mirrors 132, 132′, 132″. For example, lenses 134, 134′ can be arranged to make the light beam 12b bigger, and the mirrors 132′, 132″ direct the SLM input light beam 12c to be near perpendicular to the SLM 118 without overlapping with the SLM output excitation light. The SLM 118 changes the angle of the incident light it receives using one or more diffraction patterns or gratings, such that the space between light beams is changed. The SLM 118 is used to create a certain incident angle and thus change the axial and lateral interference pattern of the excitation light. The SLM pattern is selected based on the optical layout of the system, including but not limited to, the numerical aperture and the magnification of the objectives, and the lenses that are used.

Diffracted light from the SLM 118 is transmitted through a linear polarizer 138, which aligns the light to generate a linear light output. The light then passes through a quarter wave plate 140, which rotates the light to ensure that it has circular polarization. The light then passes through a lens 134″, which focuses two modulated light beams 12ca, 12d to the azimuthal linear polarizer 124. Diffracted light beams 12ca, 12d from the SLM 118 become s-polarized by the azimuthal linear polarizer 124. The input diffracted light 12ca, 12d is circularly polarized, and the AP 124 converts the light into linearly polarized light, which is then s-polarized light at the objective 112, whereby the light's electric field is perpendicular to the plane of incidence. Subsequently, one or two beams are selected using Fourier filters 126 arranged on a selection device, here shown as a filter wheel 128, and located at the conjugate plane of the objective backfocal plane for MAxSIM (+/−1^{st}-order beam). As shown, the first light beam 12ca is blocked by the Fourier mask 126b, and only the second light beam 12d passes through the mask 126b to the lense 134′″, which converts the polarized light beam to a parallel beam of excitation light 12e. The inverted microscope 116 passes the excitation light 12e to the HCM 10. Lenses 134″ and 134′″ form a pair, where the beam focused by lens 134″ at the conjugate backfocal plane 114 of the objective (where fourier filters are located) becomes parallel by 134″.

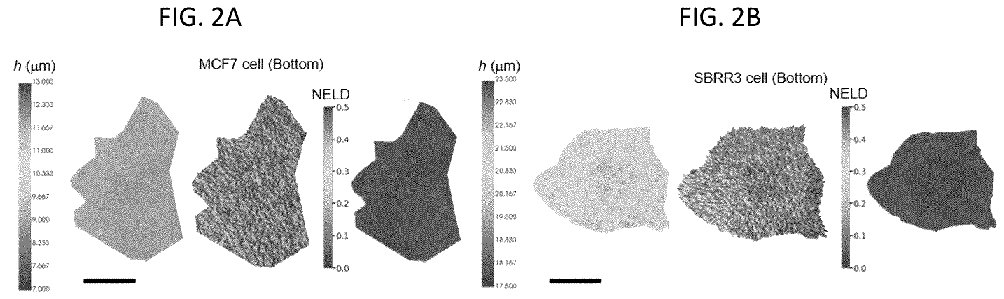

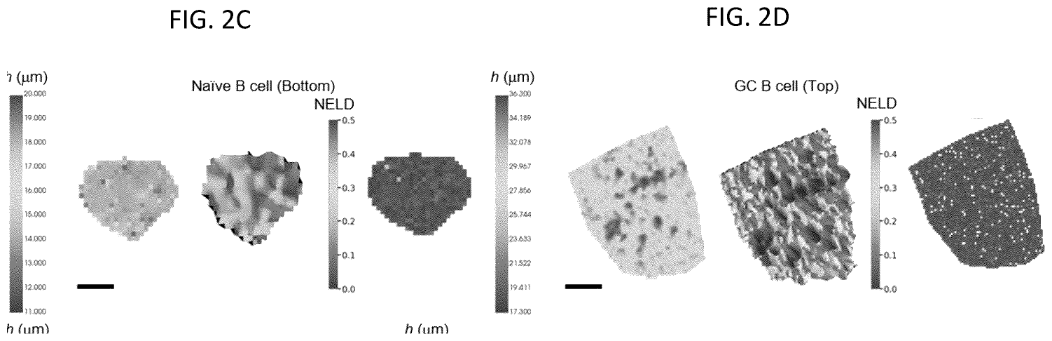

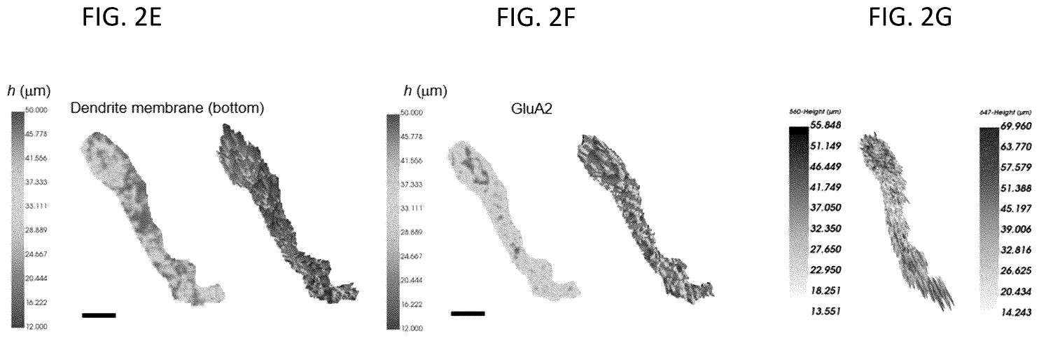

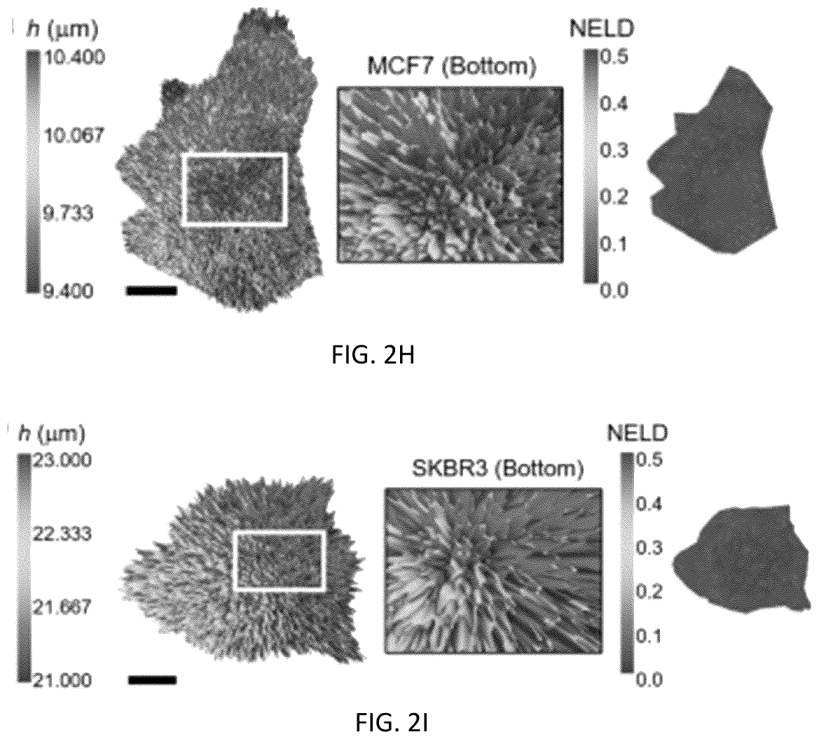

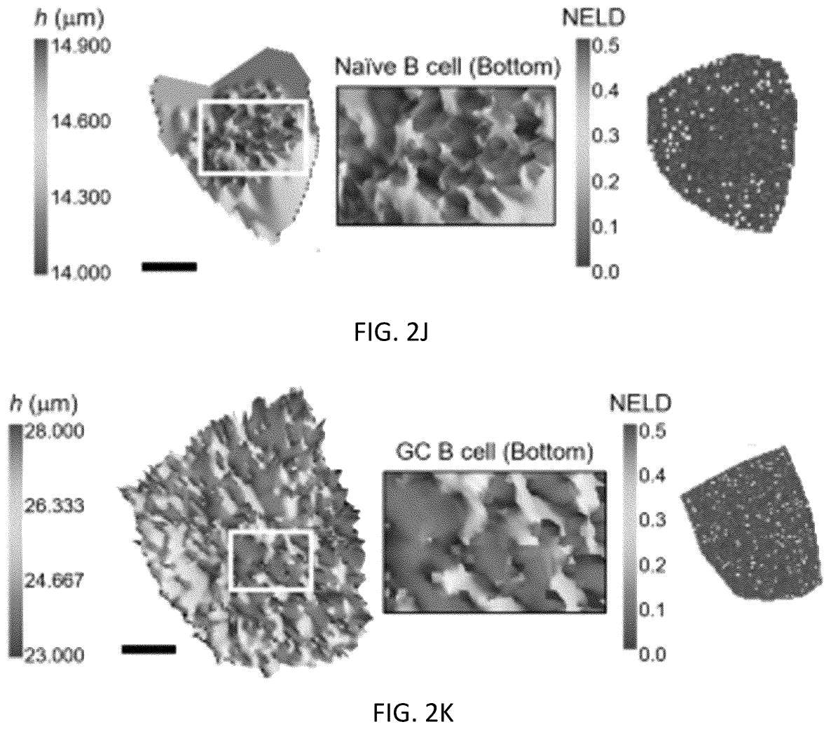

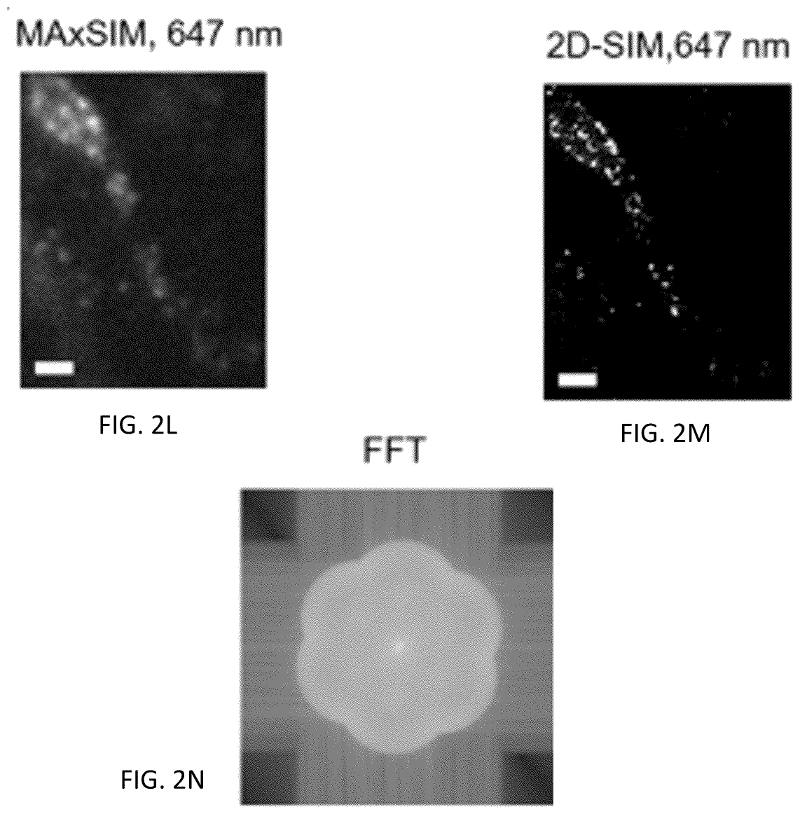

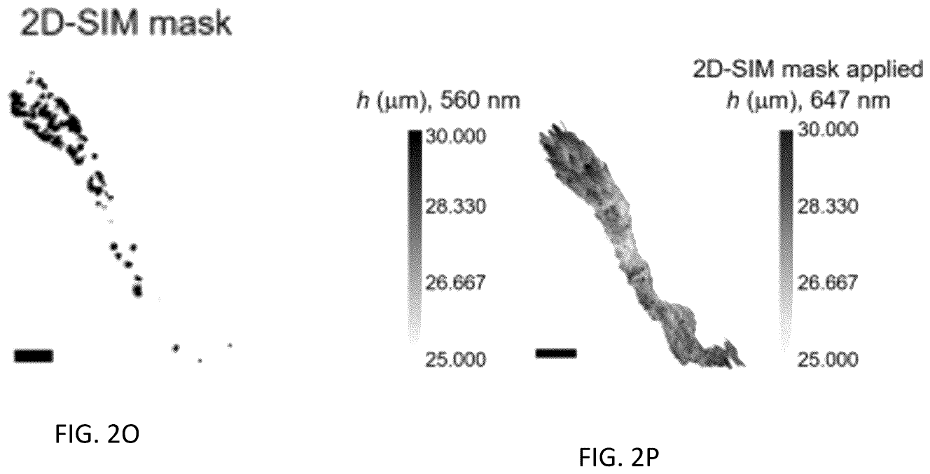

The high-speed filter wheel 128 (filter switching time <30 ms) can be rotated between the fourier mask (MAXSIM) 126b and the fourier mask (2D-SIM) 126a (which forms interference in the lateral dimension), to allow for different imaging modes for the same imaging areas of cells. For instance, selection of the ±1^{st}-order diffraction beams enables 2D-SIM imaging of the same cells, even with the presence of an HCM, as lateral interference of the symmetric ±1^{st}-order beams is intact with the HCM (FIG. 2). The selected s-polarized diffraction beams form a grating pattern through interference at the sample plane (FIG. 1D). It is further noted that although a rotating wheel 128 is provided as the selection device to select between the 2D-SIM mask 126a and the MAxSIM mask 126b, any suitable mechanism can be utilized.

The excitation light 12e is transmitted through the inverted microscope 116 to strike the sample 18, where it produces an incident angle and an axial interference pattern on the z-axis. In FIG. 1A, the incident angle is the angle between the incoming light 12e (to the sample 18 and the SiO₂ layer 106) and the optical axis (perpendicular to the sample plane). The excitation light 12e causes the sample 18 to generate an emission of fluorescent light 14a. That fluorescent emission 14a passes through the inverted microscope to the lens 134′″, and is then directed to a detector 130, here by being reflected by the dichroic mirror 136 to another mirror 132′″, and through a lens 134″″ to focus the fluorescent emission 14b to the sCMOS (complementary metal oxide semiconductor) 130. The light is collected at the sCMOS 130, which comprises image sensors that detect the fluorescence image data.

Thus, the inverted microscope 116 passes the excitation light 12e from the SIM layout 20 to the HCM 10. And, the inverted microscope 116 collects emitting light 14a from the sample 18 in response to the excitation light 12e, and passes that emitted light 14a to the SIM layout 20, where the cell fluorescence image can be captured by the detector 130. The emitting light 14a is collected from the sample 18 through an objective 112 of the inverted microscope 116, against the backfocal plane 114 using a spatial light modulator (SLM) 118, as described herein. The SLM 118 provides rapid changes of axial interference patterns for axial (i.e., z-axis) light microscopy by changing the angle of incident excitation light and change the spacing between light beams using the different diffraction patterns. Thus, the MAxSIM 100 is able to detect the axial interference pattern generated by the sample 18.

Referring to FIG. 1C, different SLM grid patterns can be created to generate light beams with different incident angles at the objective tip (FIG. 1C). Different SLM patterns (i.e., input to the SLM 118) having different spacing between lines, which create different incident angles. Two-beam axial interferometry using both ±1^{st}-order beams as used in 2D-SIM was not selected because the axial interference pattern varied laterally, complicating height reconstruction, unlike in the one-beam scenario where axial interference was laterally constant (FIG. 1D; top). In two-beam geometry with symmetric incident light beams relative to the optical axis with the presence of a mirror, the normalized lateral interference pattern was the same regardless of the axial position. Thus, 2D-SIM is still enabled in the MAxSIM hardware configuration. At the same time, 3D-SIM is not possible due to altered lateral and axial patterns by the presence of the zeroth-order beam. As used in SAIM, MAxSIM generates the incident-angle-dependent fluorescence intensity data plot. This fluorescence intensity modulation is approximately proportional to the excitation interference fringe pattern as assumed and validated in past work, and thus contains the information about the axial location of the fluorophore.

We then fit the raw data to the formula (Equation 1) for theoretical excitation intensity modulation using the damped least square algorithm (Levenberg-Marquardt), which we further refined and optimized for high-reconstruction fidelity.

$$I = {I}_{0} {\vert 1 + {r}_{eff}^{T E} {e}^{i Φ ( h )} \vert}^{2} \qquad ( 1 )$$

$${r}_{eff}^{T E} = \frac{{r}_{m \_ ox} + {r}_{ox \_ si} {e}^{i δ}}{1 + {r}_{{m}_{o x}} {r}_{o {x}_{s i}} {e}^{i δ}}$$

$$Φ ( h ) = \frac{4 π {n}_{m}}{λ} h cos ( {θ}_{w} )$$

$$δ = \frac{4 π {n}_{o x}}{λ} {d}_{o x} cos ( {θ}_{o x} )$$

In the above, I is excitation intensity variation; I₀ is a constant value; r_{eff}^{TE} is the Fresnel reflection coefficient; r_{m_ox} and rₒₓ_{ₛᵢ} are reflection coefficients at the interface between the cell medium and SiO₂ layer and between the SiO₂ and Si layers, respectively; Φ(h) is the phase difference between incident and reflected beams in the medium at h below SiO₂; nₘ₍ₒₓ₎ and θₘ₍ₒₓ₎ are refractive indices and incidence angles of the cell medium (or SiO₂); and λ is the excitation wavelength. FIG. 1E shows simulated examples of the excitation intensity modulation at different heights with varying incident angles. The intensity modulation fringes increase with greater distance from the mirror. We found that having an adequate number of modulation fringes within an incident angle range is crucial to yield high-fidelity height reconstruction. For instance, <1,000 nm empirically leads to a poor reconstruction, reinforcing the advantage of using HCM and seeding cells on the bottom glass substrate instead of placing cells directly on the mirror as used in SAIM. Additionally, the HCM enables nearly perfectly vertical placement of a mirror to the optical axis, thanks to the ridge, which is not guaranteed with the previous scheme 36, where a mirror was located above cells and a weight was placed on the mirror to prevent it from floating. It also allows custom selection of the ridge height that would lead to high-fidelity height reconstruction of a particular cell type, improving the reconstruction fidelity and time resolution compared to using a mirror without height control. To determine the reconstruction fidelity to assess localization precision, we devised a new metric called normalized extrema location difference (NELD) to assess deviations between theoretical extrema with observed extrema of incidence angle-dependent intensity curves. Deviation between theoretical (e) and observed (o) extrema positions was larger with greater peak (+) or valley (−) width. Thus, we weighted the deviation by width of the corresponding peak or valley. The equation for NELD (Equation 2) is thus:

$$N E L D = \frac{1}{{n}^{′} + {m}^{′}} ( {\sum }_{j = 2}^{n + m - 1} \frac{\sqrt{{( {θ}_{{o}_{j}^{+ ( - )}} - {θ}_{{e}_{j}^{+ ( - )}} )}^{2}}}{{( {θ}_{{o}_{j + 1}^{- ( + )}} - {θ}_{{o}_{j - 1}^{- ( + )}} )}^{2}} ) \qquad ( 2 )$$

m and n are the total numbers of maxima and minima, respectively, and m′ and n′ are the total numbers of peaks and valleys, respectively, in incident angle-dependent fluorescence intensity curves within an angle range; θₒ₍ₑ₎_{ⱼ}_{⁺} and θₒ₍ₑ₎_{ⱼ}_{^{−}} are incident angle positions that correspond to intensity maxima (+) and minima (−), respectively, in observed (o) or expected/theoretical (e) incident angle-dependent intensity curves; and (θₒ_{ⱼ₊₁}_{^{−(+)}}−θₒ_{_{j−1}}_{^{−(+)}}) is the width of an observed peak or valley. A peak or a valley is determined if a minimum or maximum location is situated between two adjacent maxima or minima.

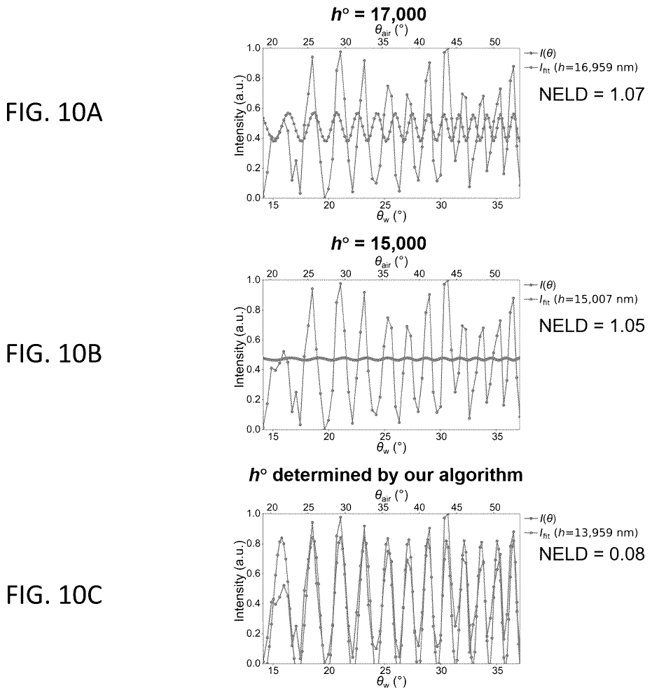

All of these optimization schemes, such as determining the optimal h0 parameter and sub-angle ranges for fitting, led to high fidelity height reconstruction (NELD<0.1 at each pixel point; NELD=0.2 is an empirically determined upper cut-off for highfidelity fitting) as shown in Supplementary FIG. 10, validating the robust nanoscale 3D topological mapping capability of our MAxSIM/HCM/reconstruction algorithm. Our Python-based height reconstruction code can be downloaded from our GitHub site. Detailed background information on our MAxSIM reconstruction algorithm is described in Supplementary FIG. 6.

We used an Alexa 488-IgG1-coated glass substrate as a control to take MAxSIM images (excitation λ=488; HCM=10.7 μm) and retrieved the height map. FIG. 1F from pixel 1 from the original wide-field fluorescence image shows an excellent fit (NELD<0.1) of the raw MAxSIM data, with an estimated height of 8,255 nm. As expected, the overall height is axially well defined as a thin layer as the roughness in the chosen ROI in Extended Data Fig was ˜0.001 (See methods). We empirically found that good MAxSIM reconstruction requires the axial location of a chromophore preferably between 5-25 μm away from the mirror to produce enough excitation and thus fluorescence intensity modulation fringes (4-21 fringes predicted from simulation) within the scanned incidence angle range. Through simulation, we determined the localization precision of axial localization in the range of 5-25 μm is theoretically ˜0.7%. Random assignment of the initial height parameter for entire pixels in an image led to significantly poor fit. To increase reconstruction fidelity, we determined the optimal initial height parameter by selecting the initial height parameter around the ridge height that minimizes the NELD value. All of these optimization schemes led to high-fidelity (NELD<0.01 at each pixel point) height reconstruction as shown in the following examples, validating the 3D topological mapping capability of MAxSIM.

We then tested the applicability of MAxSIM by probing surface morphology of the top or bottom of diverse fixed cells (cancer cells, B cells, and neuronal cells) placed on the bottom glass substrate. A ray diagram shows light beams entering and reflecting from the HCM relative to the cell location (FIG. 4). MCF7 and SKBR3 breast cancer cell lines have normal expression or overexpression of HER2 receptor tyrosine kinase, which is associated with relatively smooth or deformed plasma membrane morphologies, respectively, as shown in our previous study. For MCF7 and SKBR3 cells seeded on the bottom glass substrate, the HCM was positioned 22 μm above the cells (FIGS. 2A, 2B). As expected, roughness calculations showed an overall smoother surface for MCF7 cells compared to SKBR3 cells (0.008 versus 0.022). Activation of naïve B cells to germinal center B cells showed a similar difference in roughness—the bottom surface of naïve B cells (stained for B cell receptors) (FIG. 2C) was smoother than active germinal center B cells (FIG. 2D) (0.021 versus 0.095), which showed protrusions that elicit antigen-driven selection as part of the immune response, enhancing affinity discrimination of antigen⁴⁶. B cells were significantly smaller than MCF7 and SKBR3 cells, which could have contributed to overall greater roughness for the B cells over the total area than for the cancer cells. The relative roughness differences between MCF7 or naïve B cells and SKBR3 or GC B cells are as expected based on past results and thus validate our method in the broader context.

To determine the capability of MAxSIM to perform 2D-SIM, we then visualized protein distribution of GlutA2, a subunit of the AMPA receptor via both 2D-SIM and MAxSIM (647 nm excitation) as well as the bottom plasma membrane of neuronal dendrites using MaxSIM (560 nm) (FIG. 2E). AMPA receptors are located in synaptic sites and are responsible for most glutamatergic signaling in the brain. More GlutA2 was found in local areas colocated in spine-looking WGA-stained membrane protrusions in the dendrite (FIG. 2F). GlutA2 is reported to form “nanomodules” within dendritic spines as well as in the flat area when imaged using a super-resolution microscopy technique called stimulated emission depletion microscopy. Thus, we used super-resolution 2D-SIM (excitation numerical aperture=1.15) imaging of GlutA2 powered by MAxSIM to generate a mask to map height reconstruction from the masked area only. The overlayed 3D image of WGA and masked GlutA2 showed a few foci of GlutA2 located outside and within a spine, implying the presence of the nanomodules in the flat membrane and the synaptic membrane (FIG. 2G).

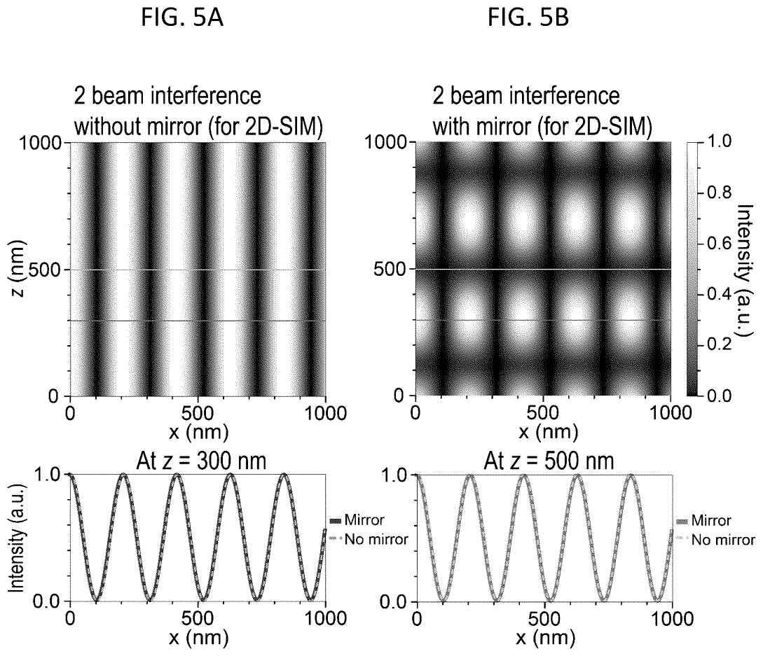

FIGS. 5A and 5B show simulated results of the two beam (+1 order beams) interference pattern in x-z without and with the presence of a mirror located perpendicular to the optical axis, respectively. The following constant values were used for the simulation: λ=488 nm, θ=60°, nₛᵢ=4.37, n_{oxide}=1.46 m, n_{media}=1.33, and the oxide layer thickness=1,000 nm. The lateral interference profiles at two z positions (300 nm; green and 500 nm; orange) show that the lateral interference patterns in the 2D-SIM geometry without a mirror (FIG. 5A; dashed line) remains intact when a mirror is positioned perpendicular to the optical axis (FIG. 5B; solid line). These figures illustrate that the MAxSIM geometry enables 2D-SIM as lateral interference of the symmetric±1^{st}-order beams remains intact with the HCM.

FIGS. 6A to 6C are graphs showing simulated incident-angle-dependent excitation intensity modulation patterns with a silicon dioxide (SiO₂) layer thickness of 1, 5, and 10 μm in the HCM at h=10 μm. As shown in the figures, a thicker oxide layer leads to an increased number of intensity modulation fringes. This finding assists the present technology in determine the optimal thickness of the oxide layer for any given sample.

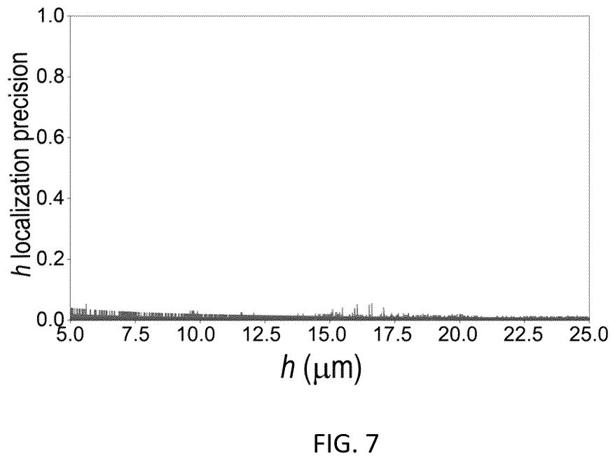

FIG. 7 is a graph where theoretical height (h) localization precision is calculated and plotted for the h from 5 to 25 μm every 1 nm. The h localization precision is calculated from the normalized difference of the observed (hₒ) and theoretical (hₑ) heights. Through simulation, we determined the axial localization precision in the range of 5-25 μm is theoretically ˜0.7%, demonstrating that the axial location of a chromophore between 5-25 μm away from the mirror produces enough excitation and thus fluorescence intensity modulation fringes within the scanned incidence angle range, resulting in high-fidelity height reconstruction.

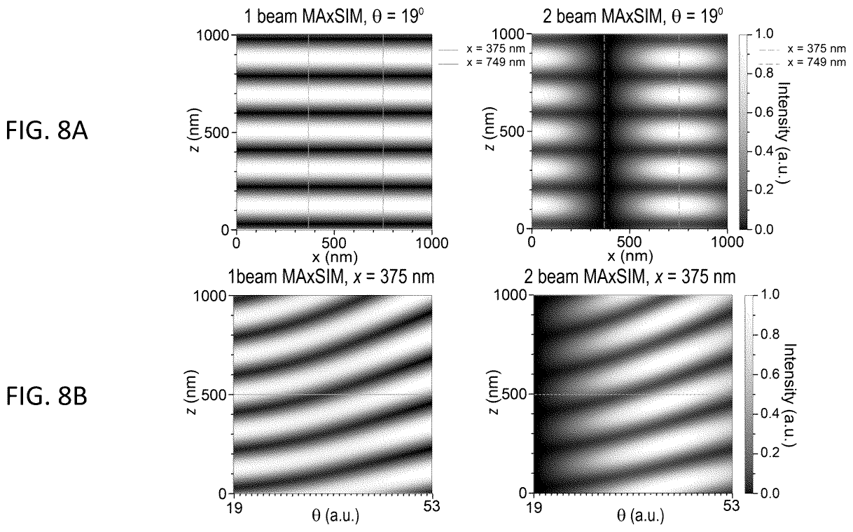

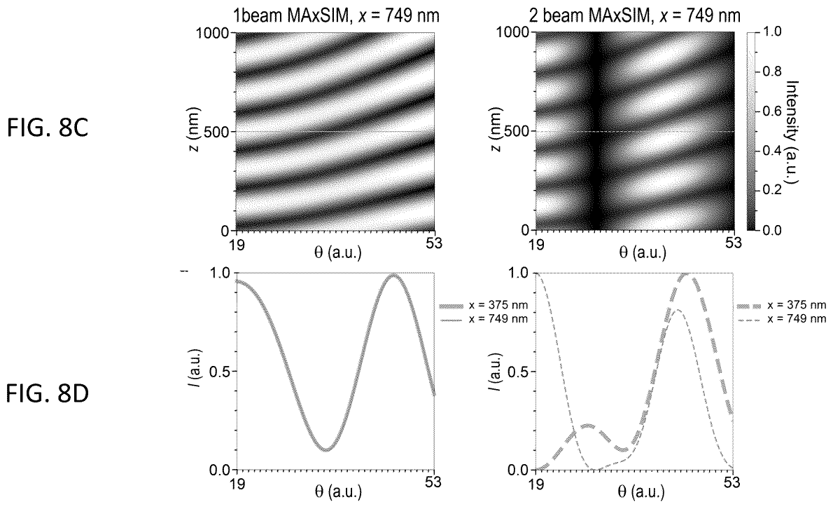

FIGS. 8A to 8C show shows simulated results of the one and two beam (±1 order beams) interference patterns in x-z at an incidence angle θ=19° with the presence of a mirror located perpendicular to the optical axis. FIG. 8D shows graphs of the intensity modulation profiles along the lines shown in FIGS. 8B and 8C overlaid for one (left: solid) and two (right; dashed) beam cases that show the modulation patterns vary laterally for the two beam case, while in the one-beam condition, those patterns are laterally invariant. Since it is more straightforward to analyze laterally constant axial interference patterns (left) than the varying case, it is more favorable to use one-beam-based axial interferometry for MAxSIM. Further, if two beams are used, the fit is more difficult because the lateral modulation pattern is not axially variant (not shown). Thus, one-beam axial interferometry using+1^{st}-order beam was selected for MAxSIM.

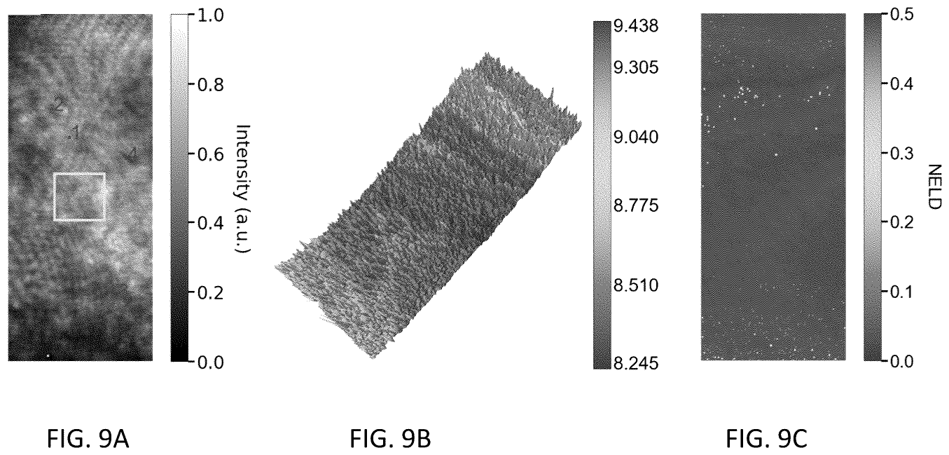

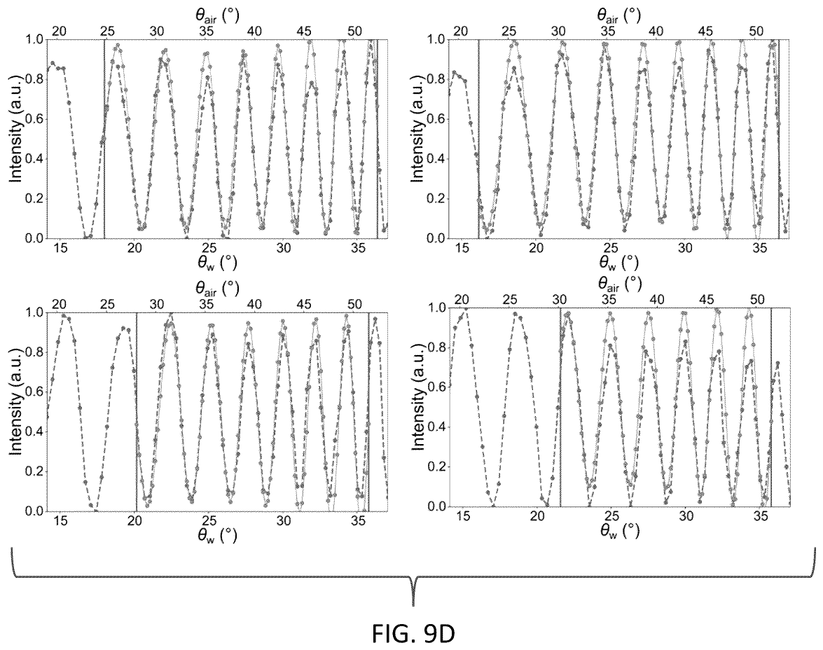

FIG. 9A is a raw MAxSIM image of Alexa-488-IgG1 spin-coated on the glass substrate taken at the incident angle of the 488 nm laser light at using the 10.7 μm high HCM. FIG. 9B is shows a representation of the reconstructed MAxSIM images in 3D. The roughness in the ROI (yellow box) is ˜0.001. Different heights can be inferred from different color scale shown in the scale bars. FIG. 9C is a 2D representation of NELD values, demonstrating the excellent fitting fidelity based on the <0.1 NELD values calculated for the selected angle ranges for fitting (purple vertical bars). FIG. 9D shows four graphs where gray and orange dotted dashed lines are processed raw data and fitted plots from the four pixels in FIG. 9A. The average NELD value was 0.035, which is indicative of the high fitting fidelity of the algorithm of the present technology.

FIG. 10A is a graph of NELD value calculations using a random initial height value of approximately 15,000 nm, FIG. 10B is a graph of NELD value calculations using a random initial height value of approximately 17,000 nm, and FIG. 10C is a graph of NELD value calculations using the fitting algorithm of the present technology. To compare our height reconstruction algorithm (FIG. 10C) with the existing methods (FIGS. 10A-B) that just applies the least square fitting without determining the appropriate initial height parameter and selecting the optimal angle range for fitting, we used random initial height values (h°=17,000 and 15,000 for a and b) that lead to very poor fits (NELD>1) compared with our result in c (NELD <0.1) showing an outstanding fitting fidelity. These results demonstrate the importance of determining the optimal initial height parameter for high-fidelity height reconstruction by selecting the initial height parameter around the ridge height that minimizes the NELD value.

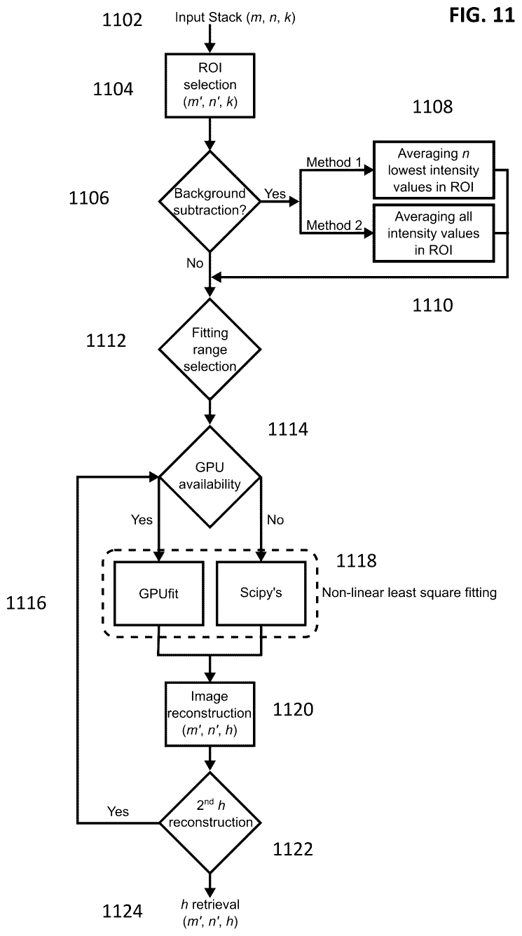

FIG. 11 is a flow diagram of an exemplary fitting algorithm used by the present system for height reconstruction. The software process may be performed at a computer or other processor associated with the system and commences the input of data 1102, where a raw MAxSIM dataset comprises a set of 2D images taken at k different incident angles θₐᵢᵣ within a range. For instance, if the θₐᵢᵣ range is (19°, 53°) with a 0.5° step size as in our default setting, k is 68. The input stack dimension is thus (m,n,k), where m and n are the numbers of x and y pixels and k corresponds to the total number of θₐᵢᵣ. The process then proceeds to ROI selection 1104, where image reconstruction can proceed in a region of interest (ROI). An ROI can be defined as a rectangle or a polygon. A user can define one rectangle ROI or multiple polygon ROIs at a given time. A left click on the mouse can be used to draw a polygon and a right click will complete the polygon.

Following ROI selection, the system determines whether or not to perform background substraction 1106 of the data. Background subtraction of the acquired 2D images can be crucial for high-fidelity least square fitting of the angle-dependent fluorescence intensity I(θₐᵢᵣ) data to the theoretical formula at a given pixel point. There are two methods for performing background subtraction, and the system can use either one. The system may set the background intensity value in each image by calculating an average value of 1) the n lowest (user-defined) intensity values of the whole image 1108 or 2) the total intensity values within an ROI 1110. The system then proceeds to fitting range selection processes 1112. Based on GPU availability 1114, the system next performs the customization of the Levenberg-Marquardt algorithm for height retrieval. The system determines which angle ranges to use for actual fitting before running the Levenberg-Marquardt algorithm. In that process, one MAxSIM raw image is taken at θₐᵢᵣ=19°, where two pixel points are indicated with red squares to showcase the reconstruction process. The GPU fitting 1116 portion of the customization is performed as follows. The raw data at each pixel is given in the form of the fluorescence intensity value at each incident angle θ within a range. The raw data at each pixel is normalized between 0 and 1 as follows:

$$I ( θ ) = \frac{I ( θ ) - min ( I ( θ ) )}{max ( I ( θ ) ) - min ( I ( θ ) )}$$

I(θ) is acquired for θₐᵢᵣ between 19° and 53° with 0.5° stepsize. After normalization, a mean intensity point is located at each mid-angle point between the two adjacent data points for better fitting. This results in increased data points located at every 0.25° between 19° and 53°.

The second component of the customization process, involving Scipy's algorithm 1118, is then performed as follows: We determine the locations of the peaks (maxima points) and valleys (minima points) in I′(θ) using the Scipy's find_peak algorithm. Following criteria were additionally used to further select the sub-angle range that yields the best fit by filtering out those peaks and valleys that do not meet the following requirements. The prominence, a parameter used in Scipy's algorithm, which is the vertical distance of a peak (or a valley) from its maximum (minimum) to the extremum position in the subsequent valley (or a peak), should be greater than the standard deviation of y-values of I′(θ). The nearest neighbor's peak (valley)-to-valley (peak) distance should be greater than two x data points (in this case, 0.5°) (for the HCM ridge height greater than 5 μm). The y-axis distances between maxima or minima points to the subsequent minima or maxima points must be greater than the threshold y-axis distance of all the maxima (or minima)-minima (maxima) pairs in I′(θ). In addition, the x-axis distance between maxima or minima points to the successive minima or maxima points must be within a specified range set by the average spacing. To determine the y-axis distance upper cut-off threshold and x-axis distance range that yields the best fitting, we use iteration. For y-axis distance upper cut-off, we vary the upper lower-off values from 5% to 55% of the average y-axis distance with a 5% increment to filter out those peaks and valleys whose y-axis distances are smaller than the lower cut-off values by determining the cut-off value that minimizes the NELD value using the LM non-linear least square fitting algorithm. For x-axis distance range, we vary the distance range that can be created using any permutation of two numbers between 50% and 100% of the averaged x-axis distance value with a 5% increment. Only those peaks and valleys that are within the x-axis distance range that was selected to minimize the NELD value can be grouped for further processing if more than 2 consecutive pairs can be found.

To filter out the peaks and valleys within groups whose y- and x-axis distances deviate significantly from the averaged values calculated from those within the groups, the selection process described in above is applied again to the data within the groups. Those remaining consecutive peaks and valleys are regrouped if there are more than 2 or 3 (user-defined) consecutive peak (or valley)-valley (or peak) pairs in a group. We apply the Levenberg-Marquardt (LM) algorithm to fit the raw data within the groups to the theoretical formula. After the fitting completes and h values are retrieved for the pixel, one selection criterion is applied to filter out those groups that did not meet the requirement. The total numbers of the extrema points between the sub-group plot of I′(θ) and the fitted plot I_{fit} must be identical. If multiple sub-groups are found, the one with the minimum NELD value is chosen for height retrieval. If those sub-groups have the same NELD values, the one associated with the lowest NELD value for the entire angle range (not within the sub-group) is chosen. For a pixel that does not have any remaining sub-groups after applying the criteria above, h=−1 is assigned for the pixel and these pixels are reprocessed during the second reconstructions 1122.

Next, at the image reconstruction 1120 step, to improve the fitting fidelity, we first redefine the selected angle range by including 3 data points before the second appearing maximum or minimum points and after the second-last pearing maximum or minimum points. Then we reshape I′(θ) within the range the we choose as a start the angles corresponding to 3 data points before the second maximum or minimum, whichever comes first, and for the end angle we chose it similarly but 3 data points after the before-last maximum or peak. Then, we reposition all the extrema positions to 1 (for maxima) or 0 (for minima positions) and the data points between them are re-scaled accordingly.

The theoretical formula describes the interference pattern of a beam interacting with its reflection from a mirror is denoted as:

$$I = {\vert 1 + {r}_{reff} {e}^{i ϕ} \vert}^{2}$$

$$I ( θ , h ) = {\vert 1 + {r}_{e f f} ( θ ) {e}^{i ϕ ( θ , h )} \vert}^{2}$$

where r_{eff}(θ) is the effective reflection coefficient and ϕ is the phase shift between the incoming and outgoing beam, which depends on the distance from the SiO₂/Si, h that is retrieved from the LM fitting. The observed fluorescence is proportional to the excitation intensity I (where a is a fitting constant) and noise (b) that is incorporated to the signal during the process of image acquisition. So I_{fit} can be simplified as the following:

$${I}_{f i t} = aI + b$$

$$or {I}_{f i t} = aI ( θ , h ) + b$$

The parameters to fit are then a, b, and h. Of the three, the parameter of interest is the distance (h) to the SiO₂/Si. To obtain a high-fidelity fit, an excellent initialization of the parameters is critical due to the presence of local minima when optimizing the residual in a least-squares regression. Our processed raw data are contained between 0 and 1, so the amplitude is initialized to 1 and the bias to 0. However, for the height we use a lookup table indicating the theoretical numbers of maxima and minima as a function of the distance to SiO₂/Si. For each tested initial height parameter, the obtained amplitude (a), bias (b), and height (h) from the LM fitting as well as the NELD value are recorded. The height associated with the lowest NELD value will be chosen as a retrieved height. If multiple sub-groups with the same lowest NELD within the angle range were found, the one that is associated with the NELD for the entire angle range will be selected.

The system then performs a second height reconstruction 1122. The second height reconstruction is performed for those pixels whose height was not retrieved (h=−1) from the first reconstruction. For the initial height parameter, we assign the h value of the nearest neighboring pixel with the lowest NELD value. That data is then provided as an output 1124.

The versatility of MAxSIM in creating custom interference patterns for excitation beams allows users to create custom image routines using various modes such as axial localization by MAxSIM, 2D-SIM, and lateral localization by SMT. MAxSIM requires scanning of incidence angles and thus is time-intensive even using SLM-based fast imaging of each frame. To increase time resolution without significantly sacrificing localization precision for achieving near-real-time imaging of live cells, we modestly reduced the angle range (19°, 53°) that was determined for fixed-cell axial localization to (19°, 35°). Having an extensive scanning angle range (19°, 53°) is favored for fixed-cell imaging because it allows better reconstruction algorithm-based selection of an angle range that is associated with the best localization precision (or lowest NELD value). However, for live-cell imaging it is desirable to narrow the scanning angle range to improve time resolution while maintaining the overall high reconstruction fidelity (NELD<0.01).

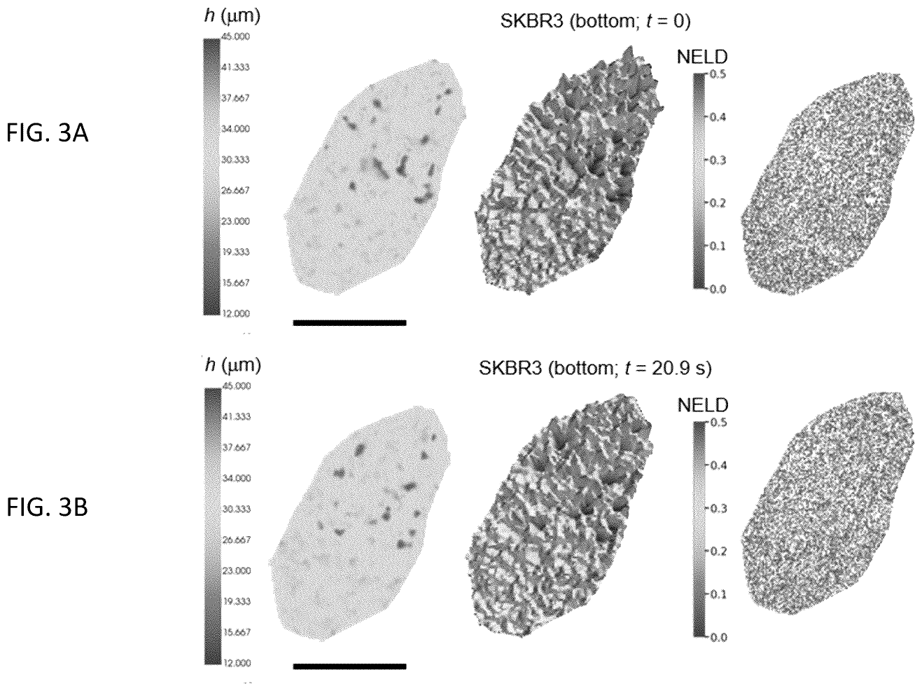

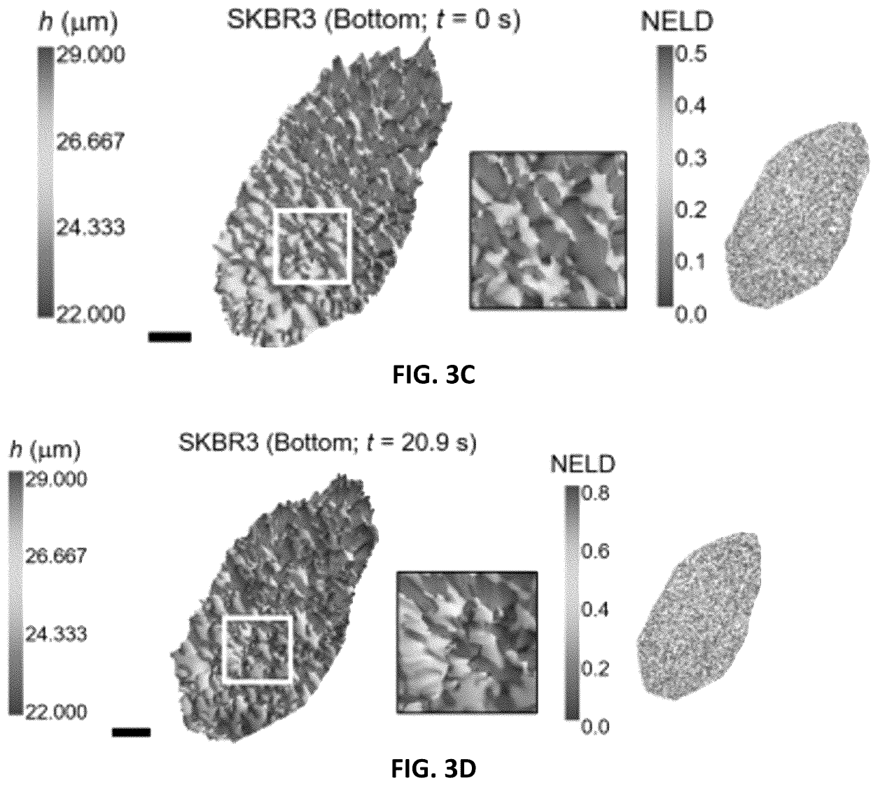

We empirically determined a suitable range (19°, 35°) for live-cell imaging. For live-cell-based MAxSIM, cell imaging was performed on WGA-Alexa 555-stained SKBR3 cells placed in a temperature, humidity, and CO₂-controlled chamber. Using 50-ms exposure time per frame, we achieved 1.9 s per MAxSIM topology image. NELD maps in the first (t=0 s) (FIG. 3A) and last (20.9 s) (FIG. 3B) topology map show that bleaching was minimal for the 28-s acquisition time, and a topology video was obtained from high-fidelity MAxSIM reconstruction.

MAxSIM with HCM offers an optoelectronic platform with robust and fine-tuned reconstruction software that allows for robust 3D nanoscale cell-surface or near-cell-surface morphological mapping in various disciplines and also live-cell-based application that can achieve near-real time (˜0.5 Hz) 3D mapping. We made use of the incident-angle-dependent intensity modulation for reconstruction and estimated localization precision by defining a new metric called NELD of extrema position differences between raw data and theoretical curves only, rather than actual shapes of the intensity curves that can vary depending on diverse experimental effects such as inclusion of background to the signal. NELD enables removal of pixels associated with poor height reconstruction, and one can have an option of interpolating the z location by nearest-neighbor averaging. Using HCM significantly enhances the reconstruction fidelity (NELD) of MAXSIM, time resolution, sample placement versatility, and reusability of the mirror. All of these developments are critical to MAxSIM function to reveal unprecedented mechanistic information about how cellular structures with different 3D membrane topologies and protein distributions affect the function of membrane proteins and their interaction with other membrane components and intracellular organelles. This information will influence understanding of cell biology by elucidating how cell functions are regulated, impacting diverse fields of life sciences research.

The present technology can be utilized in a number of different ways. For example, it can be used to perform axial localization to construct 3D topology maps and 3D single molecule tracking in near-real time if the top and the bottom of a cell (fixed or live) in a MAxSIM platform or axial localization to construct 3D topology maps of the top and the bottom of a cell (fixed or live) in a conventional SAIM platform. The HCM may also be used for enhancing the resolution of 3D-SIM. The HCM creates axial interference of the three beams (zeroth and first orders) and it can therefore enhance the resolution of 3D SIM. The HCM may also be used for correlative electronic microscopy and light microscopy (CLEM) by creating an address pattern in the HLM for indicating individual cell locations.

By using HCM, instead of placing cells on the mirror, cells can be located on the bottom of the glass substrate, with a custom fabricated HCM with ridge structure located at a specific and optimal distance above the cells, which can yield a high-fidelity height reconstruction, which cannot be achieved by locating cells on the traditional mirror. The ridge height provides important information about the initial height value, which is the most critical initial fitting parameter for determining reconstruction fidelity. By having cells on the bottom glass substrate distanced by a ridge height from the HCM, MAxSIM can image both the top and bottom of a cell and allows users to select an optimal ridge height for a given cell type to further improve height reconstruction fidelity. Moreover, cell placement on the glass side enhances SIM imaging compared to cells that are distant from the objective. Lastly, the HCM is reusable, which can save time and money because fabrication is time-consuming and costly.

### Example 1

One non-limiting example embodiment of the present disclosure is described herein.

### Methods

Cell-line culture: Cell-lines used in this work were purchased from ATCC, which were authenticated using Short Tandem Repeat analysis. We confirmed these cells were Mycoplasma-free via PCR-based analysis. MCF7 cells were maintained in RPMI 1640 with 10% FBS, and 1% L-Glutamine in the 5% CO₂ at 37° C. storage condition. SKBR3 cells were kept in DMEM with 10% FBS, and 1% L-Glutamine in the same storage condition. The condition was kept constant during the whole-imaging experiments and throughout cell preparation procedures for IF. For imaging, cells were plated on glass-bottom dishes with 14 mm glass diameter (MatTek; glass thickness: No. 1.5).

Height-controlled mirror fabrication with a ring mask: We established the following protocol. 1. Ring mask preparation: 110 nm of chromium was sputter-coated on a glass slide (25 mm×25 mm) using a sputter (CHA). The slide was coated with ˜200 nm poly(methyl methacrylate) (PMMA). The ring pattern (see FIG. 1B) was written on the slide using the electron beam lithography system (Raith Voyager) using 50 KV acceleration voltage and 8 nA current. The developed pattern was transferred to the chromium by wet Cr etch for 60 sec. 2. HCM fabrication using the ring mask: Silicon wafer coated with 1 μm of silicon dioxide was cut into 25 mm×25 mm chips. The chips were sonicated in isopropyl alcohol (IPA) for 2 min and then dried with nitrogen. Then we spin-coated the chip with SU-8 2025 photoresist at spin speeds between 2000-6000 rpm to get a film thickness between 5-30 μm. The resist was poured carefully drop by drop to the middle of the sample, which was then flattened on a glass slide to cover the whole chip. The chips were baked on a hot plate at 65° C. for 3 min and 95° C. for 9 min and then exposed to UV for 20 sec (˜200 mJ/cm2 dose) under a ring mask, followed by another post-bake at 65° C. for 2 min and 95° C. for 7 min. The samples were developed with SU-8 developer for 7 min and washed with IPA. Heating was applied to the samples to reach 120° C. for 10 min to smooth the SU-8.

Structured illumination microscopy setup: The custom SIM microscope was built on a Zeiss Axio Observer inverted microscope platform with an ASI motorized stage. A Zeiss C-apochromat 63× 1.2NA W Korr UV-VIS-IR water objective was used for both MAxSIM and SIM. Three-color (488, 560, and 647 nm) MAxSIM and 2D-SIM imaging with HCM were enabled. Sequential excitation at the two wavelengths or sequential use of the fourier filter was enabled by software-controlled two filter wheels (Finger Lakes Instrumentation). Excitation grating patterns at each wavelength were generated by a spatial light modulator (QXGA; Forth Dimension Display) as previously described. 8 Fluorescence images were collected using an sCMOS camera (Hamamatsu Flash 4.0) with an exposure time of 30 ms. 2D reconstruction of the raw data was performed using a custom software as previously described.

Cancer cell imaging with MAxSIM: The SKBR3 and MCF7 cells have been stained with WGA488 1 ug/ml in PBS for 2 min at RT right after the fixation with 4% paraformaldehyde (PFA) for 10 min. For additional f-actin staining, fixed cells were blocked with 1% BSA and permeabilized with 0.1% saponin in PBS for 5 min, followed by incubation with phalloidin-alexa 555 (Abcam) conjugates in 0.1% saponin in PBS for 1.5 hr.

B-cell preparation for MAXSIM: Tonsil cells were sorted into Naïve B cells and GC B cells based on expression of CD19, IgD and CD10 as follows: Naïve: CD19+ IgD+ CD10− and GC: CD19+ IgD− CD10+. Sorted cells were incubated at 5% CO2 and 37° C. for 2 hours. After incubation, cells were labeled for B cell receptors with Fab fragments of antibodies against IgG or IgM heavy chain. Fab fragments were conjugated to Dylight 550. Cells were activated for 8 minutes at 37° C. using antigens attached to the planar lipid bilayer prepared as described in Ambegaonkar et al. (2019). Cells were fixed with 4% paraformaldehyde for 10 min at 37° C. and stained with wheat germ agglutenene-Alexa 555 conjugates for 10 min at room temperature. Cells were washed with PBS, and chambers were packed with parafilm for courier.

Neuron cell preparation for MAxSIM imaging: Primary cortical cultures from E17-E18 Long Evans rat embryos were transfected with Lipofectamine 2000 (Invitrogen 11668019) at in vitro day 17 with pFUGW-cGFP. At in vitro day 24, cells were incubated with anti-GluA2 (Sigma Millipore AB397) (1:250) at 37° C. for 10 min. Cells were washed once with warm artificial cerebrospinal fluid. Cells were fixed with 4% paraformaldehyde/2% sucrose/0.000375% glutaraldehyde for 8 min at 37° C. Cells were washed once with artificial cerebrospinal fluid and then treated with 0.001% NaBH₄ on ice for 15 min. Cells were washed three times with artificial cerebrospinal fluid and then incubated with anti-IgG2a-Atto647N antibody (Rockland 610-156-041) (1:400) in 1% ovalbumin/0.2% cold water fish gelatin blocking buffer at room temperature for 1 h. Cells were washed three times with artificial cerebrospinal fluid and then incubated with wheat germ agglutinin (WGA)-conjugated Alexa 555 (Invitrogen W32464) for 10 min at room temperature. Cells were washed twice, and the dish was filled with ˜5 mL artificial cerebrospinal fluid for imaging and storage.

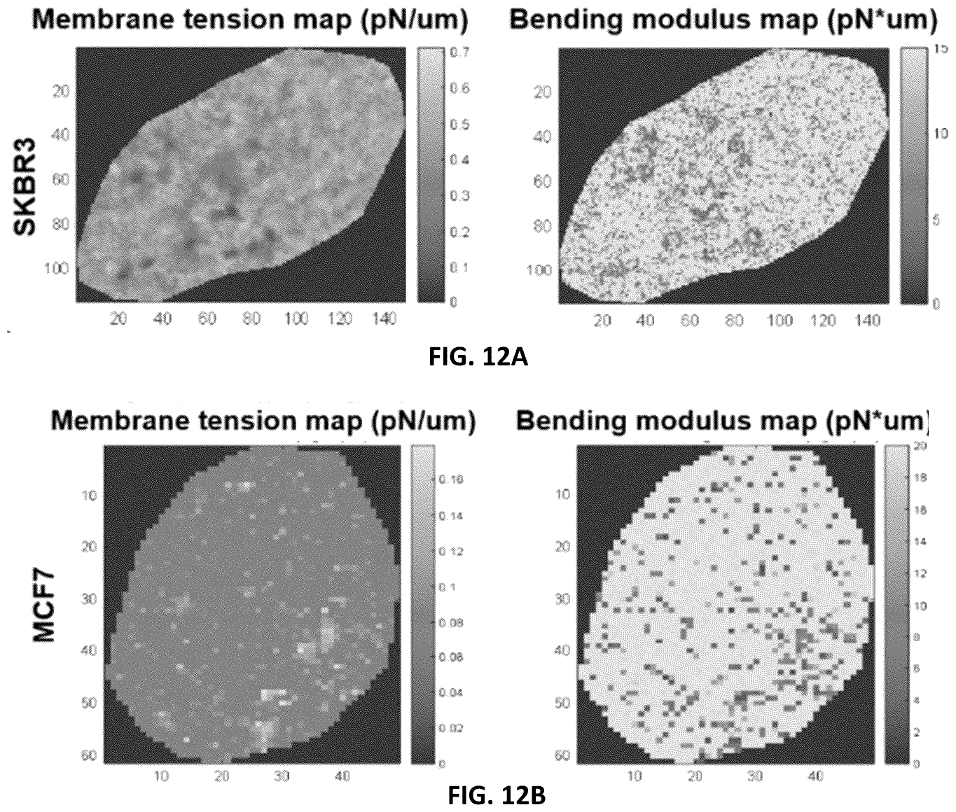

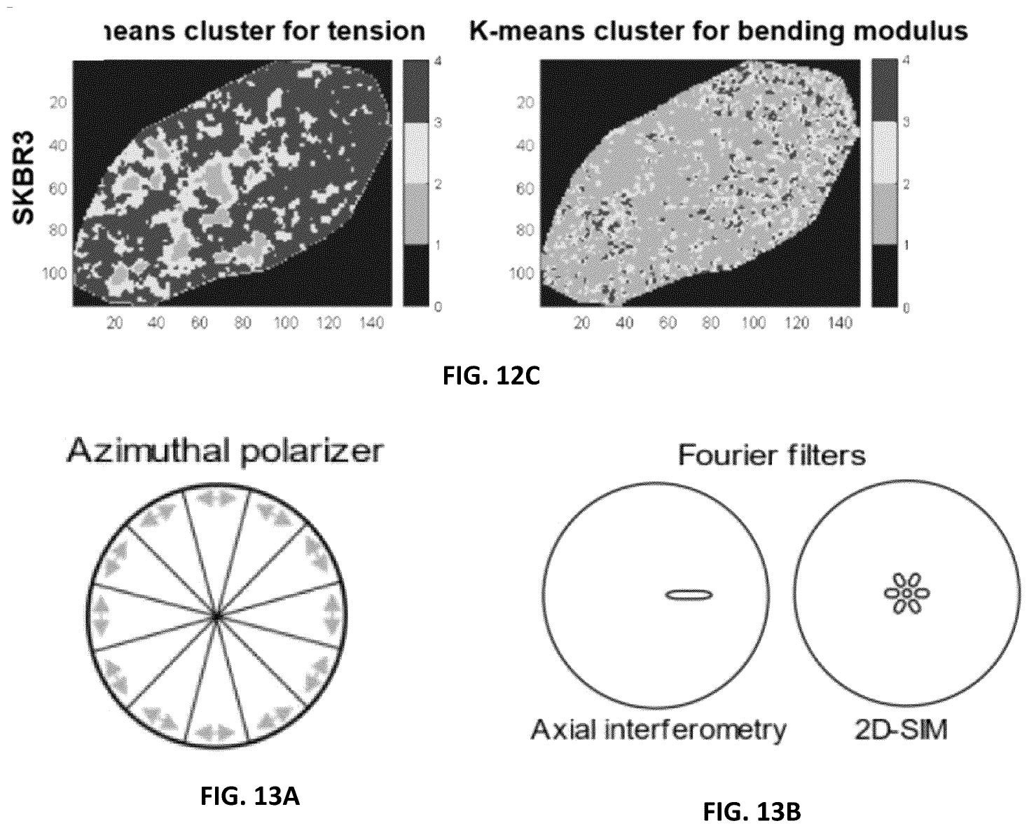

Analysis of single-pixel-level plasma membrane biomechanics in live cells using the time-dependent membrane heights acquired by MAxSIM imaging: Utilizing MAxSIM technology, we mapped the membrane tension and bending modulus of plasma membranes in MCF7 cells (low HER2 expression) and SKBR3 (HER2 overexpression enabling constitutive HER2 activity). To extract membrane tension and bending modulus from the time-dependent membrane height data at each pixel, the Fourier transform of the autocorrelation of this data is used. This approach, based on the Helfrich-Canham model, has been commonly employed in the literature, allowing the membrane tension (o) and bending modulus (K) to be linked to height fluctuations by the following equation.

$$〈 {\vert h ( q ) \vert}^{2} 〉 = \frac{{k}_{b} T}{σ {q}^{2} + κ {q}^{4}} ,$$

where [symbol] |h(q)|² [symbol] represents the power spectral density of the membrane height fluctuations, q is the wave vector, k_{b}T is the thermal energy, σ is the membrane tension, and κ is the bending modulus. From fitting the raw experimental data to this function, membrane tension (σ) and bending modulus (κ) are extracted (FIGS. 12A, 12B, 12C). To identify mechanical compartments, we will utilize and compare various cluster analysis methods we have tested, including K-means analysis, which groups similar data points into K clusters based on their proximity to cluster centers, and DBscan, a density-based clustering algorithm that groups data points based on their proximity.

Stain the plasma membrane of live cells for MAxSIM analysis: We will employ and compare DiIC18(3) and fluorescently conjugated WGA (wheat germ agglutinin), which are widely used cell membrane staining dyes also tested by us.

### Further Embodiments

The following paper is hereby incorporated by reference: Rodriguez, et al., “MAxSIM: multi-angle-crossing structured illumination microscopy with height-controlled mirror for 3D topological mapping of live cells,” COMMUNICATIONS BIOLOGY, Vol. 6, No. 1034 Oct. 12, 2023.

This study leverages our innovative MAxSIM technology, a significant breakthrough in mapping mechanical properties across the entire plasma membrane, facilitating the spatial correlation of mechanical properties with receptor organization via simultaneous single-molecule tracking of cell-surface receptors. MAxSIM is multi-functional, also offering the visualization of the cortical cytoskeletal distribution by enabling super-resolution SIM imaging in the same cells, merging high-resolution imaging with functional insights.

Our custom SIM, breaking the diffraction limit via patterned excitation light beams, can be used in various modes, ranging from 2D-SIM (FIG. 1G) with variations like TIRF- and leaky TIRF-SIM to 3D-SIM. 2D-SIM is still enabled in MAxSIM configuration where a height-controlled mirror is placed on top of cells on the glass bottom dish to generate axial interference patterns, making the use of 2D-SIM and MAxSIM interchangeably.

1. Super-resolution imaging and single-molecule-tracking tools and mechanical property measurements: a. Multi-angle crossing structured illumination microscopy (MAxSIM): We developed the recently published innovative MAxSIM for nanoscale axial localization of plasma membrane height at each pixel in real time in live cells, coupled with super-resolution lateral imaging by SIM (FIGS. 1A-1G). This method leverages optoelectronics to create multiple incident angles, a technique similar to that used in structured illumination microscopy (SIM). MAXSIM effectively addresses and overcomes the limitations of traditional axial interferometry, which faces challenges in 3D mapping of live cell surfaces, spatially unrestrained imaging (only basal plasma membranes have been mapped), and breaking the diffraction limits. By integrating a custom-fabricated mirror for creating the axial interferometry patterns to SIM optoelectronic layout and employing an optimized height reconstruction algorithm, MAxSIM significantly improves axial localization fidelity and enhances temporal resolution compared to existing axial nanoscopy tools, enabling more effective real-time 3D imaging of the entire plasma membranes of live cells and super-resolution lateral SIM imaging. b. Deriving membrane tension and bending modulus from membrane height fluctuations: To extract membrane tension and bending modulus from the time-dependent membrane height data at each pixel, the Fourier transform of the autocorrelation of this data is used. This approach, based on the Helfrich-Canham model70, has been commonly employed in the literature, allowing the membrane tension (σ) and bending modulus (κ) to be linked to height fluctuations by the following equation: [symbol] |h(q)|\hat{ }2 [symbol] =(k_{b} T)/(σq2+κq⁴), where [symbol] |h(q)|² [symbol] represents the power spectral density of the membrane height fluctuations, q is the wave vector, k_{b}T is the thermal energy, σ is the membrane tension, and κ is the bending modulus. From fitting the raw experimental data to this function, membrane tension (σ) and bending modulus (κ) are extracted (FIB. 1B, Aim 1-PD).

We chose HCM ridge heights of ˜11 and 22 μm to cover MCF7 and SKBR3 cells seeded on the bottom glass substrate, respectively. We recommend to use a HCM that is taller than the cell height to ensure that the mirror is positioned above the measured cells to perform MAxSIM on both basal (FIG. 2H, 2I) cell surface. We compared the Gaussian widths of the height distributions between the MCF7 cells (width: 784 nm) and the SKBR3 cells (width: 1410 nm) in FIG. 2. As predicted, the average widths for three MCF7 cells were 493±315 nm (n=3), which is smaller than that for three SKBR3 cells, 1009±594 nm (n=3).

Naive B cells and germinal center (GC) B cells differ in their intrinsic antigen affinity thresholds for activation that correlate with the cellular architecture of their PM-expressed B cell receptors (BCRs). When placed on antigen-containing planar lipid bilayers, naive B cells form flat contacts with the bilayer and show uniform distribution of BCRs. In contrast, GC B cells form actin-rich, pod-like structures that concentrate BCRs at tips that contact the bilayer. Consistent with this observation, the basal surface of naive B cells (stained for BCRs) was flatter (Gaussian width: 427 nm; FIG. 2J) than the basal surface of GC B cells (1702 nm; FIG. 2K), which showed protrusions that may facilitate antigen-driven selection as part of the immune response, enhancing affinity discrimination of antigen. We noted heterogeneity in the plasma membrane morphologies and height distributions of both naive B and GC B cells, potentially due to variations in local antigen densities in the lipid bilayer. Therefore, we did not conduct statistical comparisons. The differential MAxSIM cell surface topologies of displayed MCF7 and naive B cells versus SKBR3 and GC B cells, respectively, align with previous results and thus broadly validate our method.

Rather than overlaying the laterally diffraction-limited MAxSIM image of GluA2 (FIG. 2L) to the MAXSIM image of WGA we employed super-resolution 2D-SIM imaging with an excitation numerical aperture of 1.15 (FIG. 2M, 2N) on GluA2 to generate a mask (FIG. 2O) to map height reconstruction solely from the masked area. The overlaid 3D image of WGA and masked GluA2 clearly showed a few sub-micron sized foci of GluA2 located within and outside PM protrusions, implying GluA2 forms nanoclusters throughout the PM of the dendrite (FIG. 2P), which is not explicitly evident in the diffraction-limited MAxSIM image overlay. This example demonstrates how the superresolution lateral imaging capability of MAxSIM can enhance the 3D mapping of cell surface protein distributions by more accurately defining lateral protein localizations.

The versatility of MAXSIM in creating custom interference patterns for excitation beams allows users to create custom imaging routines incorporating various modes such as axial localization by MAxSIM, 2D-SIM, and nanometer-scale lateral localization by single-molecule tracking. MAxSIM requires scanning of incident angles and thus is time-intensive, even when using SLM-based fast imaging of each frame. To achieve higher time resolution without compromising localization accuracy for near-real-time imaging of live cells, we modestlyreduced the angle range (19°, 53°) previously determined for axial localization in fixed cells. Having a large scanning angle range is favored for fixed-cell imaging because it allows better height reconstruction via algorithm-based selection of an optimal subangle range associated with the lowest NELD value for fitting. However, for live-cell imaging, it is desirable to narrow the scanning angle range to improve time resolution while maintaining overall high reconstruction fidelity.

Experimentally, we determined a suitable range (19°, 35°) for live-cell imaging with MAxSIM. Shorter angle ranges can lead to poorer height determination fidelity. Some of the pixels that cannot be assigned to heights can be interpolated using the nearest neighboring pixels that were assigned with heights with sufficiently high-fidelity reconstruction (NELD<0.2). Imaging was performed on live, WGA-555-stained SKBR3 cells in full growth medium in a temperature-, humidity-, and CO2-controlled chamber. Using a 50-ms exposure per frame, we achieved 1.9 s per MAxSIM topology image. The comparable overall NELD values in the initial (t=0 s) (FIG. 3C) and final (t=20.9 s) (FIG. 3D) topology maps indicate minimal bleaching over ˜ 20-s acquisition time, signifying high-fidelity MAxSIM height reconstruction in live cells (See temporal progression of the raw fluorescence images and NELD (<0.2) values for ˜21 s). Future efforts should be made to further improve time resolution for live-cell imaging while maintaining excellent fitting fidelity by utilizing more photostable and brighter chromophores, such as Janelia Farm dyes, and fine-tuning SiO₂ thickness.

The live-cell and near-real-time imaging capability of MAxSIM prompted us to extend our technique to 3D single-molecule tracking. For simultaneous detection of 3D membrane topology and 3D single-molecule locations, we leveraged the photophysical properties of quantum dots (QDs), whose absorption is more a continuum at the higher energy of the first absorption peak40. We used the same excitation at 560 nm for WGA-555 and QD605 for MAxSIM and single molecule tracking, respectively, by continuously generating 68 images every 3.3 s from scanning the incidence angle range (19°, 53°) with 0.5° step. All 68 frames were used to track QDs laterally, and we could achieve ˜20 Hz single-molecule tracking with z locations obtained every 3.3 s. These results successfully demonstrate the versatility of MAxSIM for 3D topological mapping of live cells and 3D single-molecule tracking.

The development of various super-resolution optical techniques has enabled cellular imaging with a greatly improved axial resolution. For instance, widefield-based super-resolution methods such as 3D-structured illumination microscopy (3D-SIM) can achieve twice the axial resolution (˜300 nm) of widefield microscopy by creating 3D interference patterns for sample excitation. Stimulated emission depletion (STED) microscopy can yield six-fold improved axial resolution (˜100 nm) by narrowing the point spread function using a bottle-shaped STED beam. Further, 4Pi and 15M microscopy attain seven times the axial resolution (˜100 nm) of widefield microscopy by generating axial interference patterns using two opposing objectives. 3D localization-based microscopy, such as interferometric PALM (iPALM) 46 (localization accuracy <20 nm), 3D-STORM48 (20-30 nm), and point spread function engineering methods51,52 (10-20 nm), also perform axial localization with high accuracy.

Our MAxSIM with an HCM uses SLM-based optoelectronic control of incident angles to generate angle-dependent fluorescence image data and can incorporate 2D-SIM functionality; our fine-tuned reconstruction software enables high-fidelity height reconstruction of MAxSIM images. Together, the hardware and software MAxSIM/HCM platform allows for 3D nanoscale cell surface morphological mapping and also live-cell application that can achieve near-real-time (˜0.5 Hz) 3D topology mapping and 3D single-molecule tracking. It also enables super-resolution lateral imaging by enabling 2D-SIM. Employing an HCM greatly enhances the reconstruction fidelity of MAxSIM by allowing more accurate prediction of the initial height parameter, which is essential for fitting raw intensity data to the theoretical curve, and permitting versatile sample placement and reusability of the HCM. To assess height localization accuracy, we defined a new metric called NELD that measures extrema position differences between raw intensity data and theoretical curves. The NELD metric for assessing localization accuracy is superior to using the actual shapes of intensity curves, which can vary depending on experimental conditions such as inclusion of background signals.

Our examples demonstrate that the MAxSIM platform can be applied for diverse research questions, including revealing unprecedented mechanistic information about critical cellular processes by providing robust details about how 3D PM topologies influence membrane protein functions and interactions with other cellular components. Obtaining real-time 3D topology information of live cells can provide new insights into the regulation and deregulation of crucial cellular processes, thereby influencing diverse fields of life sciences and clinical research.

HCM fabrication with ring mask. To prepare the ring mask, 110 nm of chromium was sputter-coated on a glass slide (25 mm×25 mm) using a sputter (CHA criterion). The slide was coated with ˜200 nm poly(methyl methacrylate). The ring pattern (see FIG. 1B) was written on the slide using an electron beam lithography system (Raith Voyager) with 50 kV acceleration voltage and 8 nA current. The developed pattern was transferred to the chromium by wet etch for 60 s.

For HCM fabrication using the ring mask, a silicon wafer covered with 1 μm of thermal SiO₂ was cut into 35 mm×35 mm chips. Chips were sonicated in isopropyl alcohol for 2 min and then dried with nitrogen. Chips were spin-coated with SU-8 2005 or SU-8 2025 photoresist at spin speeds of 2000-6000 rpm to achieve a film thickness of 5-30 μm. Chips were baked on a hot plate at 65° C. for 3 min and 95° C. for 9 min and then exposed to UV for 20 s (˜200 mJ/cm2) under a ring mask, followed by another post-bake at 65° C. for 2 min and 95° C. for 7 min. Samples were developed with SU-8 developer for 7 min and washed with isopropyl alcohol. Samples were heated to 120° C. for 10 min to smooth the SU-8.

A setscrew (Thorlabs, SS25S050V), with a nut (N25S0440) as a weight (FIG. 1A) was used to secure the HCM in place on top of cells in a medium.

HCM cleaning procedure. The HCM is reusable if the following cleaning steps are adhered to. 1. Dunk the used HCM in fresh 100% isopropanol for 10 min. 2. Rinse it with deionized water for 2 min. 3. Air dry the HCM. 4. Store it in a dust-free storage box. Our group has used the same HCM for over 2 years. The photoresist we use, SU-8, is known for its remarkable resistance (https://kayakuam.com/products/su-8-series-and-kmpr-plasmaremoval-rework/), which contributes to the durability of our HCM.

MAxSIM setup. The custom SIM microscope was built on a Zeiss Axio Observer inverted microscope platform with an ASI motorized stage. A Zeiss C-apochromat 63×1.2NA W Korr UVVIS-IR water objective (WD=0.17 mm) was used for both MAxSIM and SIM. We tested different objectives, each varying in working distances (WD=0.15-0.4 mm at D=0.17 mm), immersion media (water and glycerin), and numerical aperture (NA=1.15-1.3). After thorough evaluation, we identified that a 63× water objective with 1.2 NA (Objective C-Apochromat 63×/1.20 W Corr M27 WD=0.28 mm at D=0.17 mm) was the most suitable for MAxSIM. This particular objective allowed for a large excitation scan range and provided sufficient photon collection for our purposes. Although a glycerin objective with similar capabilities (63×, NA=1.3, WD=0.17 mm at D=0.17 mm) could also be used, we ultimately chose the water immersion objective, because of our observation that glycerin sometimes failed to uniformly cover the objective tip, leading to nonreproducible incident angles. To ensure successful implementation of MAxSIM, it is crucial to carefully select an objective by evaluating the accuracy and precision of the incident angles in the desired scan range using different SLM patterns. The minimum requirements for an objective to perform MAxSIM are 63×, NA=1.2 (water), and WD>0.15 mm. VSIM, an open-source software developed by HHMI, was used to control SIM electronics. Three-color (488, 560, and 647 nm) MAxSIM and 2D-SIM imaging with an HCM were enabled. Sequential excitation at the two wavelengths or sequential use of the Fourier filter was enabled by two software-controlled filter wheels (Finger LakesInstrumentation). Excitation grating patterns at each wavelength were generated by SLM (Forth Dimension Display). Fluorescence images were collected using a sCMOS camera (Hamamatsu Flash 4.0) with an exposure time of 30 ms. 2D reconstruction of the raw data was performed using custom software.

FIGS. 13A, 13B, IC show another non-limiting embodiment of the present disclosure. In FIG. 13A, an Azimuthal polarizer 124 is shown in further detail. In FIG. 13B, Fourier filters are shown for use as masks 126, including an Axial interferometry mask and a 2D-SIM mask. The interferometry mask 126 has an elongated hole so that light hits at different position to control excitation light angle. This hole is defined empirically based on the positions at the conjugate plane of the back focal plane where the +1st or −1st order diffracted beams from the spatial light modulator (SLM), which displays grating patterns, correspond to each end of the incident angle range. The position and size of the hole is based on the angle of the incident light. The incoming light sees the grating pattern and is diffracted. For larger incident angles, the grating patterns are tighter, so that different lights are diffracted differently. The angles change based on the grating pattern. A longer hole is needed for MAxSIM than 2D SIM. As illustrated in FIG. 1C, the larger the incident angle, the tighter the grating pattern that is needed (bottom two figures in FIG. 1C). And the smaller the incident angle of light, the larger the grating pattern (top two figures in FIG. 1C).

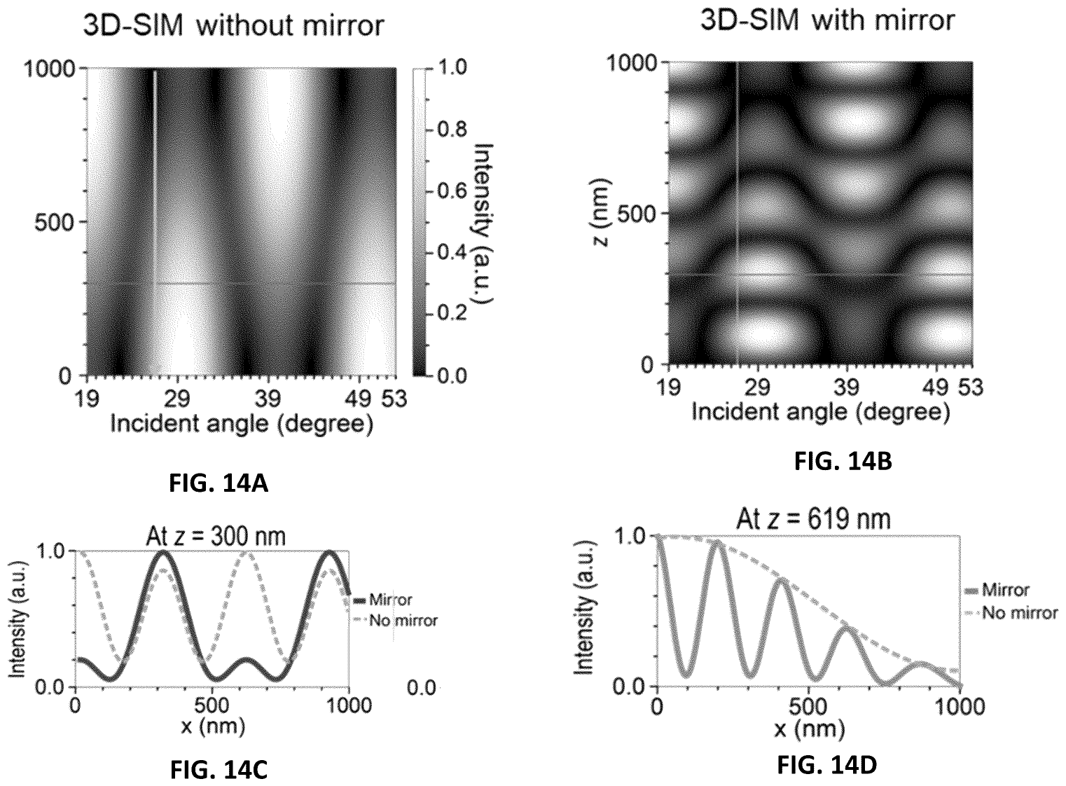

Referring to FIGS. 14A-14D, our simulation results demonstrate the interference of 3D-SIM beams above the objective, both without and with a mirror. The intensity profiles below compare the horizontal (green solid and dashed lines) and vertical (orange solid and dashed lines) intensity modulations, both with and without the mirror. In the case without the mirror, the half-intensity fringe of the 3D-SIM is compared to approximately 4.5 fringes with the mirror, suggesting a potential ninefold increase in axial resolution through the use of a mirror.

It is further noted that the present disclosure extends beyond mere axial localization. It also significantly enhances the axial resolution of the 3D-SIM microscope. For instance, our simulation results demonstrate a marked improvement in the z-axis resolution of the 3D-SIM when a HCM is employed.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention. All references cited herein are incorporated by reference in their entireties.

1. An apparatus for microscopic imaging comprising:
an inverted microscope directed at a sample on a coverglass and a silicon mirror coated with a light modulation layer of specified thickness, said sample comprised of one or more cells and one or more chromophores; and
a ridge separating the coverglass from the light modulation layer;
wherein the silicon mirror is situated on the light modulation layer, opposite the ridge and the coverglass.

2. The apparatus of claim 1, wherein said silicon mirror is prime-grade and said light modulation layer is a silicon dioxide layer.

3. The apparatus of claim 1, wherein the ridge is fabricated from a silica-coated silicon chip.

4. The apparatus of claim 1, wherein the apparatus performs fixed cell imaging and live cell imaging.

5. The apparatus of claim 1, wherein a weight is situated against the silicon mirror, opposite the light modulation layer.

6. The apparatus of claim 1, wherein the inverted microscope uses a spatial light modulator to diffract light through a linear polarizer and a filter wheel comprised of one or more Fourier filters, and wherein a beam of polarized light is directed to the silicon mirror to create axial light modulation with its reflection on the silicon mirror, producing image data captured at an image sensor.

7. The apparatus for microscopic imaging of claim 1, further comprising a light source generating an input light beam, wherein said inverted microsope comprises:
a spatial light modulator that receives the input light beam and applies a spatial light modulation pattern based on an optical layout to diffract the input light beam and provide a plurality of diffracted light beams;
a linear polarizer that receives the plurality of diffracted light beams from the spatial light modulator and linearly polarizes the plurality of diffracted light beams to provide a plurality of linearly polarized diffracted light beams;
a quarter wave plate that receives the plurality of linearly polarized diffracted light beams from the linear polarizer and circularly polarizes the plurality of linearly polarized diffracted light beams to generate a plurality of circularly polarized light beams;
an Azimuthal polarizer that receives the plurality of circularly polarized light beams and generates linearly polarized light; and
a Fourier filter that receives the linearly polarized light from the Azimuthal polarizer and selects one or more beams of linearly polarized light, wherein the Fourier filter is comprised of one or more Fourier masks, wherein the selected one or more beams of linearly polarized light are transmitted to a microscope to strike the sample.

8. The apparatus of claim 1, wherein the selected beams of light produce an incident angle and an axial interference pattern on the z-axis of the sample.

9. The apparatus of claim 1, further comprising an azimuthally linear polarizer that is located adjacent to the Fourier filter, wherein the diffracted excitation light is transmitted through the azimuthally linear polarizer.

10. A method of microscopic imaging comprising:
directing an inverted microscope at a sample on a coverglass and a silicon mirror, the sample comprised of one or more cells and one or more chromophores;
separating the coverglass from a light modulation layer with a ridge;
situating the silicon mirror on the light modulation layer, opposite the ridge and coverglass; and
situating a weight against the silicon mirror, opposite the light modulation layer.

11. The method of claim 10, wherein the ridge is fabricated from a silica-coated silicon chip.

12. The method of claim 10, wherein the polarized light is s-polarized.

13. The method of claim 10, wherein the linear polarizer is an azimuthal linear polarizer.

14. The method of claim 10, further comprising performing fixed cell imaging, live cell imaging, and model system imaging.

15. The method of claim 10, wherein the light modulation layer is a silicon dioxide layer.

16. The method of claim 10, wherein a weight is situated against the silicon mirror, opposite the light modulation layer.

17. The method of claim 10, wherein the inverted microscope uses a spatial light modulator to diffract light through a linear polarizer and a filter wheel comprised of one or more Fourier filters, and wherein a beam of polarized light is directed to the silicon mirror to create axial light modulation with its reflection on the silicon mirror, producing image data captured at an image sensor.

18. The method claim 10, further comprising:
receiving excitation light at a spatial light modulator;
applying a spatial light modulation pattern based on an optical layout of the inverted microscope to diffract the excitation light;
transmitting the diffracted excitation light through a quarter wave plate and a linear polarizer;
selecting one or more beams of light using a Fourier filter, wherein the Fourier filter is comprised of one or more fourier masks; and
transmitting the selected beams of light to the microscope to strike a sample.

19. The method of claim 17, wherein the selected beams of light produce an incident angle and an axial interference pattern on the z-axis of the sample.

20. The method of claim 17, further comprising transmitting the diffracted excitation light through an azimuthally linear polarizer that is located adjacent to the Fourier filter.

21. A height-controlled mirror comprised of:
a silicon mirror;
a light modulation layer situated on the silicon mirror; and
a ridge fabricated on the light modulation layer, wherein the ridge has a ridge height that is configured to space a glass substrate from the light modulation layer at a specific distance.

22. The mirror of claim 21, wherein said light modulation layer is a silicon dioxide layer.

23. The mirror of claim 20, wherein the mirror perpendicular to optical axis improves lateral and axial imaging resolution in microscopy.

24. The mirror of claim 20, wherein the light modulation layer has a thickness, and the thickness of the light modulation layer controls accuracy of the ridge height.

25. The mirror of claim 20, wherein the ridge height is 5-30 μm.
